(19) United States
(12) Patent Application Publication
(10) Pub. No.: US 2026/0147727 A1
(43) Pub. Date: May 28, 2026

(54) CABLING ASSIST SYSTEM

(71) Applicant: Dell Products L.P., Round Rock, TX (US)

(72) Inventors: Padmanabhan Narayanan, Chennai (IN); Per Henrik Fremrot, Novato, CA (US); Erik P. Smith, Douglas, MA (US)

(21) Appl. No.: 18/961,623

(22) Filed: Nov. 27, 2024

(51) Int. Cl. G06F 13/42

(52) U.S. Cl. CPC G06F 13/4282; G06F 2213/0042; G06F 2213/3814

(57) ABSTRACT

A cabling assist system includes a user device, a computing device including a port, and a cabling assist device that includes a port connector and a transceiver device connector. The cabling assist device connects to the port included on the computing device via the port connector, receives port connection information for the port from the computing device, and transmits the port connection information to the user device. The user device determines port connection options for the port using the port connection information, and displays the port connection options. The cabling assist device then connects to a transceiver device via the transceiver device connector, retrieves transceiver information from the transceiver device, and transmits the transceiver information to the user device. The user device then determines that the transceiver information corresponds to a first of the port connection options, and identifies the first of the port connection options that are being displayed.

### BACKGROUND

The present disclosure relates generally to information handling systems, and more particularly to the cabling of information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, networking devices (e.g., switch devices), server devices, storage system, and/or other computing devices known in the art, may be cabled together in a fabric in order to allow for the transfer of information between those computing devices. It is desirable to design and deploy/update fabrics as quickly as possible, and several techniques for fabric provisioning have been developed to achieve those goals. For example, fabric management systems such as the Fabric Design Center (FDC) from DELL® Inc. of Round Rock, Texas, United States, automates many of the operations involved in the creation of a complete fabric plan (e.g., switch/server/storage rack placements, configurations, connectivity, cabling details, and/or other fabric information known in the art), and Zero Touch Provisioning (ZTP) techniques automate many of the operations involved in the verification of that fabric plan once the computing device have been connected together.

As will be appreciated by one of skill in the art in possession of the present disclosure, the fabric plan discussed above may identify ports on switch devices that should be cabled together in order to provide the fabric, and may be utilized to generate a respective “job plan” for each fabric connection technician involved in the connection of the computing devices to provide the fabric. Those fabric connection technicians may then operate as per their respective job plans to connect the computing devices to provide the fabric, and once those job plans have been carried out by the fabric connection technicians, the fabric connections may be automatically verified (e.g., using Link Layer Discovery Protocol (LLDP) communications and verification scripts). As such, while fabric creation and fabric connection verification are substantially automated, the actual connection of the computing devices in the fabric remains a manual operation. Furthermore, while fabric administrators tend to have relatively extensive knowledge of the computing devices (e.g., Command Line Interface (CLI) operations and other tools that allow for the performance of validation/troubleshooting) and the fabric connection options (e.g., 1G to 400G transceiver devices and corresponding cabling options, direct-attach cabling options, breakout modes, port configurations that may affect link status, etc.), the fabric connection technicians that are relied on to actually physically connect the computing devices to provide the fabric according to their respective job sheets tend to lack that level of knowledge.

In addition, those fabric connection technicians often operate in a time-constrained and physically-constrained environment that presents further challenges with the connection of the computing device in the fabric. For example, the fabric connection component inventory is typically not co-located with the computing device(s) being connected, which requires the fabric connection technician to identify and collect the relevant transceiver devices/corresponding cabling and/or direct-attach cabling (e.g., in a “crash cart”) before transporting them to the location of the computing device(s) to-be connected. Furthermore, in some cases, switch devices positioned at the top of a rack may only be accessible via a ladder, while switch devices positioned at the bottom of a rack may present difficulties as well. Further still, the ability to accurately identify computing devices, ports, transceiver devices/corresponding cables, direct-attach cabling, and/or other fabric connection components may be difficult due to light pollution, poor lighting, lack of clear/visible information on the computing devices, fabric connection component identifiers (e.g., Quick Response (QR) codes or bar codes) not being accompanied by descriptions, discrepancies between network operating system port number schemes and the port numbering printed on the switch devices, and/or other issues that would be apparent to one of skill in the art in possession of the present disclosure. Yet further still, during the fabric connection process, fabric connection technicians may perform voice calls with fabric administrators while having to carry transceiver devices/corresponding cabling and/or direct-attach cabling, which often precludes the use of relatively large mobile devices (e.g., laptop/notebook computing devices) or tethered devices (e.g., desktop computing devices) that would reduce fabric connection technician agility.

Thus, the manual operations combined with the challenging fabric connection environment makes conventional fabric connection technique error-prone, and may result in links between computing devices not being available due to fabric connection issues. For example, common fabric connection errors include the incorrect selection of direct-attach cabling or a transceiver device and/or corresponding cable, the connection of a correctly selected transceiver device or direct-attach cable to an incorrect port or an incorrect switch device, configuration mismatches, and/or other fabric connection issues that may then require subsequent fault isolation procedures and further manual intervention by a fabric connection technician or fabric administrator to remedy the issue.

Accordingly, it would be desirable to provide cabling assist system that addresses the issues discussed above.

### SUMMARY

According to one embodiment, an Information Handling System (IHS) includes a chassis; a port connector that is included on the chassis; a transceiver device connector that is included on the chassis; a processing system that is coupled to the port connector and the transceiver device connector; and a memory system that is coupled to the processing system and that includes instructions that, when executed by the processing system, cause the processing system to provide a cabling assist engine that is configured to: connect, via the port connector, to a first port included on a first computing device; receive, from the first computing device, first port connection information for the first port; transmit, to a user device, the first port connection information; connect, via the transceiver device connector, to a first transceiver device; retrieve, from the first transceiver device, first transceiver information; and transmit, to the user device, the first transceiver information.

### BRIEF DESCRIPTION OF THE DRAWINGS

FIG. 1 is a schematic view illustrating an embodiment of an Information Handling System (IHS).

FIG. 2A is a perspective view illustrating an embodiment of a cabling assist device that may be provided according to the teachings of the present disclosure.

FIG. 2B is a side view illustrating an embodiment of the cabling assist device of FIG. 2A.

FIG. 2C is a front view illustrating an embodiment of the cabling assist device of FIG. 2A.

FIG. 3 is a schematic view illustrating an embodiment of the cabling assist device of FIGS. 2A-2C.

FIG. 4 is a flow chart illustrating an embodiment of a method for assisting with the cabling of computing devices.

FIG. 5 is a schematic view illustrating an embodiment of networking devices that may be used with the cabling assist device during the method of FIG. 4.

FIG. 6 is a schematic view illustrating an embodiment of the cabling assist device of FIGS. 2A-2C connected to one of the networking devices of FIG. 5 during the method of FIG. 4.

FIG. 7A is a schematic view illustrating an embodiment of the networking device connected to the cabling assist device of FIG. 6 and operating during the method of FIG. 4.

FIG. 7B is a schematic view illustrating an embodiment of the cabling assist device of FIG. 3 operating during the method of FIG. 4.

FIG. 8A is a schematic view illustrating an embodiment of the networking device connected to the cabling assist device of FIG. 6 and operating during the method of FIG. 4.

FIG. 8B is a schematic view illustrating an embodiment of the cabling assist device of FIG. 3 operating during the method of FIG. 4.

FIG. 9 is a schematic view illustrating an embodiment of the cabling assist device of FIG. 3 operating during the method of FIG. 4.

FIG. 10 is a schematic view illustrating an embodiment of the cabling assist device of FIG. 3 operating during the method of FIG. 4.

FIG. 11A is a schematic view illustrating an embodiment of the cabling assist device of FIG. 3 operating during the method of FIG. 4.

FIG. 11B is a schematic view illustrating an embodiment of the cabling assist device of FIG. 6 disconnected from the networking device and operating with a user device during the method of FIG. 4.

FIG. 12A is a schematic view illustrating an embodiment of the cabling assist device of FIG. 3 operating during the method of FIG. 4.

FIG. 12B is a schematic view illustrating an embodiment of the cabling assist device and the user device of FIG. 11B operating during the method of FIG. 4.

FIG. 13 is a schematic view illustrating an embodiment of the user device of FIG. 12B operating during the method of FIG. 4.

FIG. 14 is a schematic view illustrating an embodiment of a transceiver device connected to the cabling assist device of FIG. 12B during the method of FIG. 4.

FIG. 15A is a schematic view illustrating an embodiment of the transceiver device and the cabling assist device of FIG. 14 operating during the method of FIG. 4.

FIG. 15B is a schematic view illustrating an embodiment of the cabling assist device of FIG. 3 operating during the method of FIG. 4.

FIG. 16 is a schematic view illustrating an embodiment of the cabling assist device of FIG. 3 operating during the method of FIG. 4.

FIG. 17A is a schematic view illustrating an embodiment of the cabling assist device of FIG. 3 operating during the method of FIG. 4.

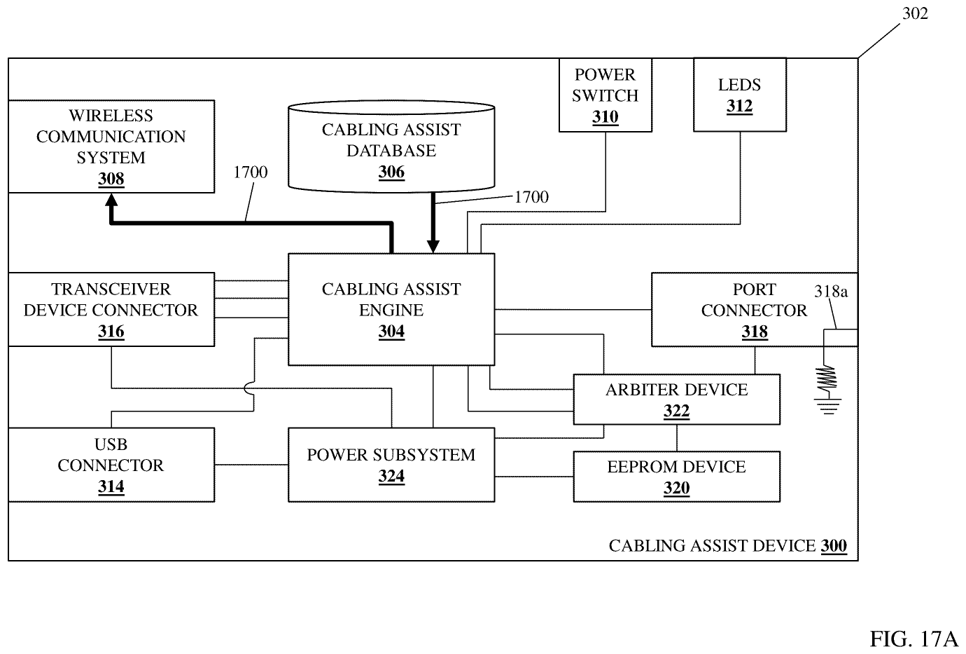

FIG. 17B is a schematic view illustrating an embodiment of the cabling assist device and the user device of FIG. 14 operating during the method of FIG. 4.

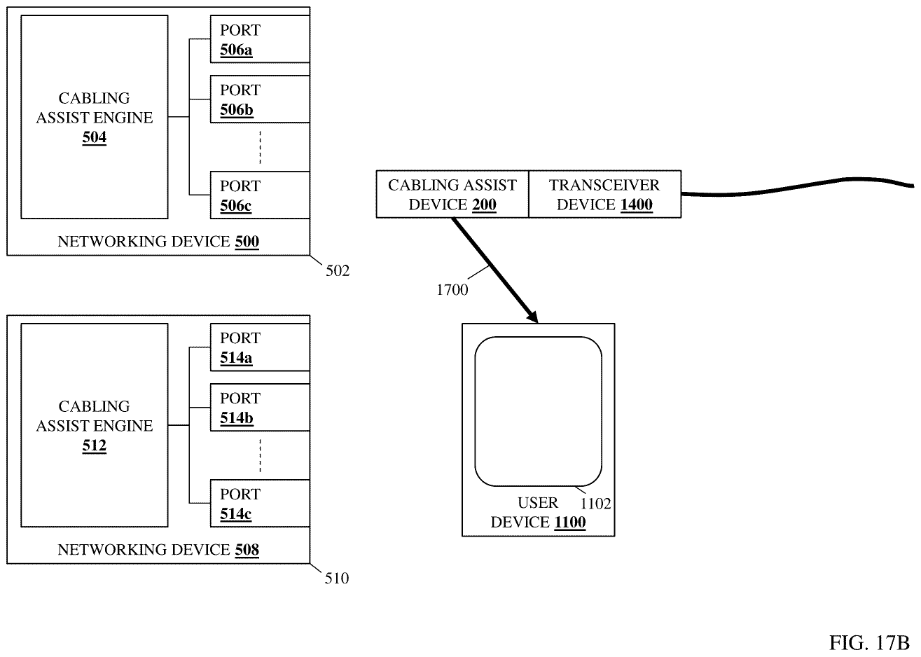

FIG. 18 is a schematic view illustrating an embodiment of the user device of FIG. 17B operating during the method of FIG. 4.

FIG. 19A is a schematic view illustrating an embodiment of the cabling assist device of FIGS. 2A-2C connected to a first port on one of the networking devices of FIG. 5 during the method of FIG. 4.

FIG. 19B is a schematic view illustrating an embodiment of the cabling assist device of FIGS. 2A-2C connected to a second port on the one of the networking devices of FIG. 5 during the method of FIG. 4.

FIG. 20A is a schematic view illustrating an embodiment of the cabling assist device and the user device of FIGS. 14, 19A, and 19B operating during the method of FIG. 4.

FIG. 20B is a schematic view illustrating an embodiment of the cabling assist device of FIG. 3 operating during the method of FIG. 4.

FIG. 20C is a schematic view illustrating an embodiment of the cabling assist device and the user device of FIG. 14 operating during the method of FIG. 4.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

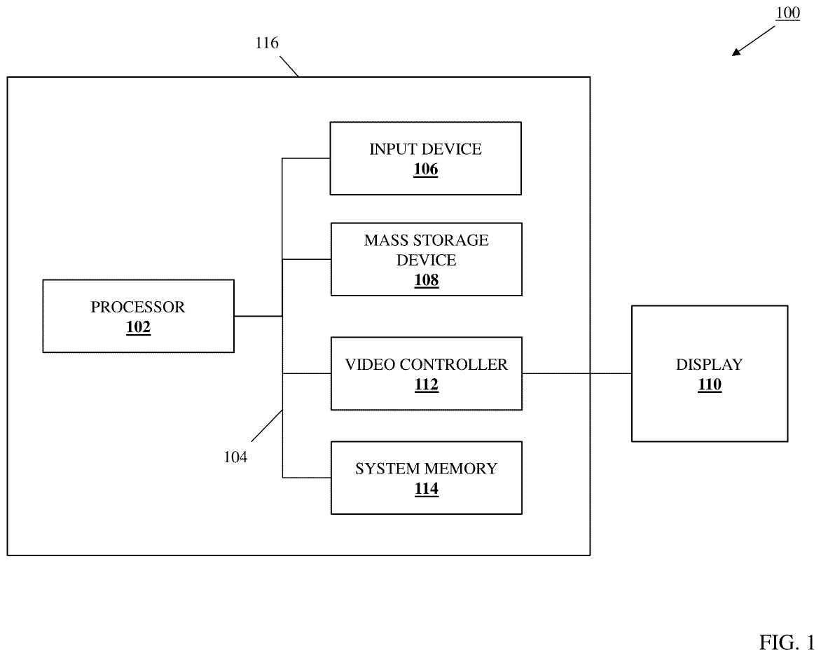

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

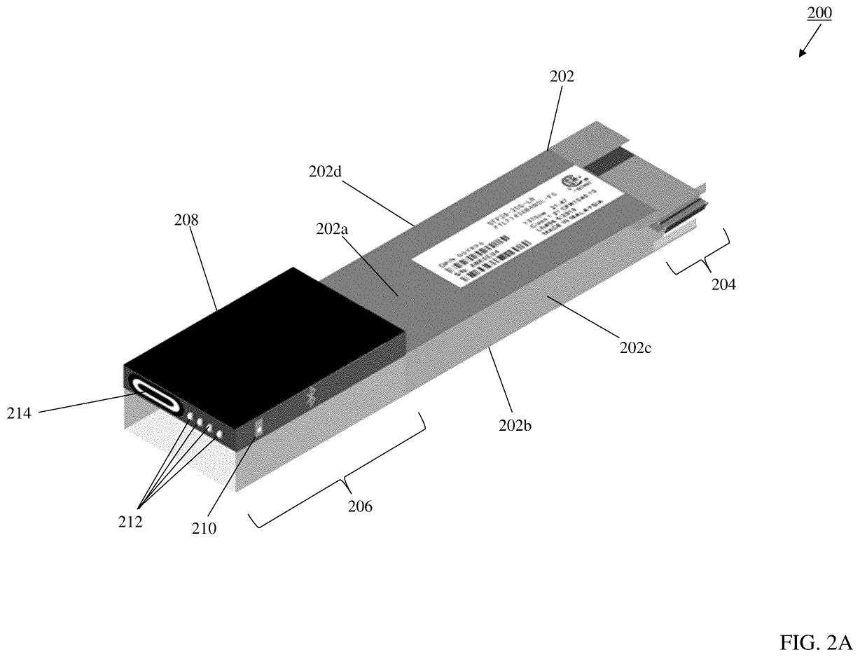

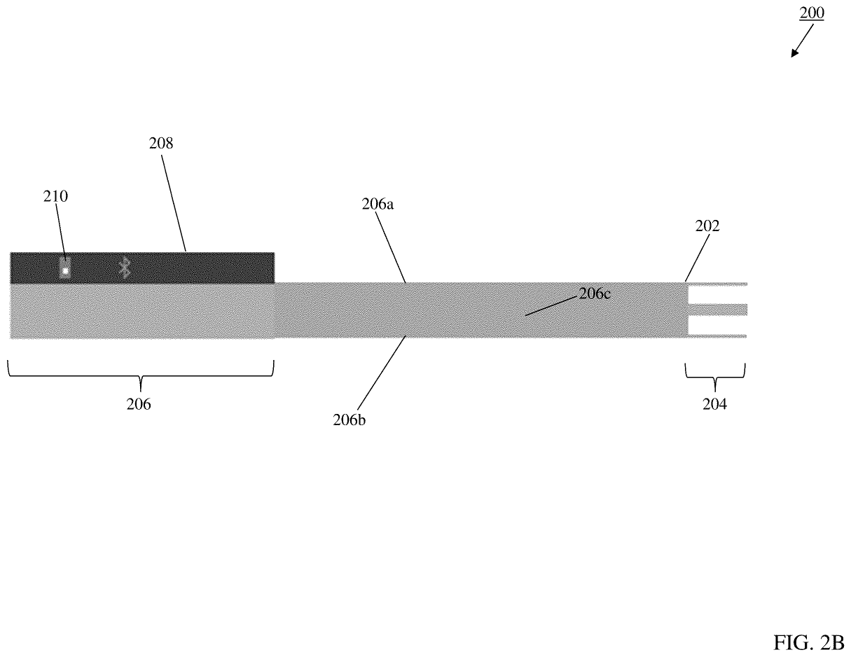

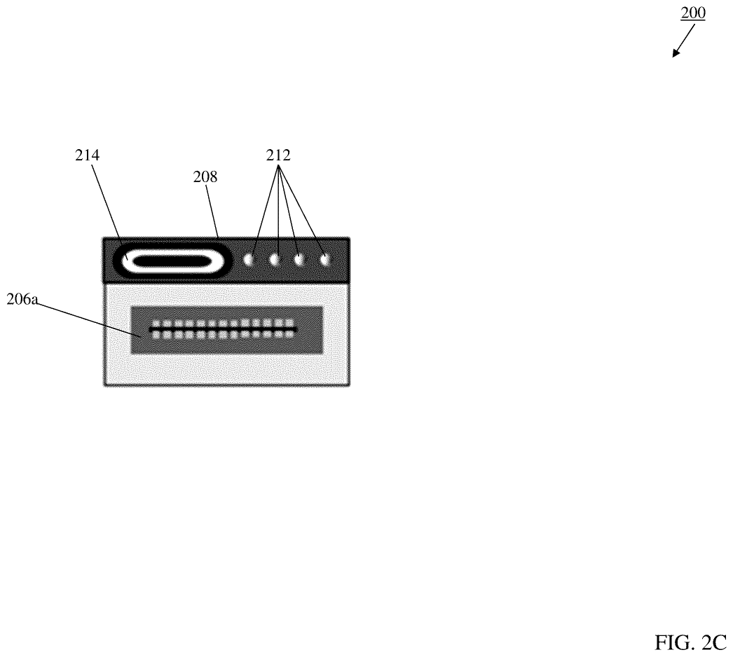

Referring now to FIGS. 2A, 2B, and 2C, an embodiment of a cabling assist device 200 that may be provided according to the teachings of the present disclosure is illustrated. In the illustrated embodiment, the cabling assist device 200 includes a chassis 202 having a top surface 202a, a bottom surface 202b that is located opposite the chassis 202 from the top surface 202a, and a pair of opposing side surfaces 202c and 202d that extend between the top surface 202a and the bottom surface 202b and that are located opposite the chassis 202 from each other. In some examples, the chassis 202 may be provided using any of a variety of metal/metal alloy materials that one of skill in the art in possession of the present disclosure will recognize are used to provide the chassis of conventional transceiver devices.

A port connector 204 is located on an end of the chassis 202. In the examples illustrated and described below, the port connector 204 is provided by a Quad Small Form-factor Pluggable (QSFP) transceiver port connector-like structure (e.g., a “module card edge” connector) that is configured to connect to a QSFP transceiver port on a switch device, although one of skill in the art in possession of the present disclosure will appreciate how a variety of other types of port connectors (e.g., QSFP Double Density (QSFP-DD) port connectors, Octal Small Form-factor Pluggable (OSFP) port connectors, enhanced Small Form-factor Pluggable (SFP+) port connectors, etc.) on other types of computing devices (e.g., server devices, storage systems, etc.) will fall within the scope of the present disclosure as well. As will be appreciated by one of skill in the art in possession of the present disclosure, in some embodiments, the chassis 202 and the port connector 204 may be provided with a height (i.e., as measured between the top surface 202a and the bottom surface 202b of the chassis 202), a width (i.e., as measured between the side surfaces 202c and 202d), and a length that conforms to QSFP Multi-Source Agreement (MSA) specifications in order to allow chassis 202 and port connector 204 to be positioned in a transceiver device port on a computing device such that the port connector 204 engages with a transceiver device connector in that computing device.

A transceiver device connector 206 is located on an end of the chassis 202 that is opposite the chassis 202 from the port connector 204. In the examples illustrated and described below, the transceiver device connector 206 includes a QSFP transceiver connector that is configured to connect to a QSFP transceiver device, although one of skill in the art in possession of the present disclosure will appreciate how a variety of other types of transceiver connectors that are configured to connect to a variety of other types of transceiver devices (e.g., QSFP-DD transceiver connectors, OSFP transceiver connectors, SFP+ transceiver connectors, etc.) will fall within the scope of the present disclosure as well. As described in further detail below, the transceiver device connector 206 may include a “mini-cage” having a transceiver device connection element 206a (visible in FIG. 2C) that may be provided by a QSFP type connector, with a height and width that conform to the QSFP MSA specifications discussed above, but with a length that is relatively shorter than required by QSFP MSA specifications (e.g., the length of the transceiver device connector 206 may be one-third the length of transceiver devices that are configured to connect to the transceiver device connector 206). As will be appreciated by one of skill in the art in possession of the present disclosure, the length of the transceiver device connector 206 may allow a transceiver device to engage the cabling assist device 200 when each are held in a respective hand of a user, but need not include the additional length the is required by QSFP MSA specifications in order to provide mechanical support for transceiver devices.

In the illustrated example, a component element 208 is included on the top surface 202a of the chassis 202. In the examples provided below, a power switch 210 is included on the component element 208 and may be configured to activate and deactivate the cabling assist device 200. Furthermore, a plurality of light emitting devices 212 are included on the component element 208 and may include the power Light Emitting Device (LED), the wireless indicator LED, the computing device activity LED, and the transceiver device activity LED discussed below, and/or any other LEDs that would be apparent to one of skill in the art in possession of the present disclosure.

Further still, a Universal Serial Bus (USB) connector 214 is included on the component element 208 and may be configured for use in providing power to the cabling assist device 200 (e.g., via its connection to a power source to power the cabling assist device 200 or charge a power subsystem included therein), enabling communications with the cabling assist device 200, and/or performing any other USB connector operations that would be apparent to one of skill in the art in possession of the present disclosure. While the USB connector 214 is illustrated and described as being provided by a USB-C connector, one of skill in the art in possession of the present disclosure will appreciate how other types of USB connectors (e.g., USB-A, USB-B, micro-USB, mini-USB, etc.) and/or other types of non-USB connectors may be utilized to provide the functionality of the USB connector 214 while remaining within the scope of the present disclosure as well. Furthermore, while a specific cabling assist device 200 has been illustrated and described, one of skill in the art in possession of the present disclosure will recognize that the cabling assist device of the present disclosure may include a variety of components and component configurations for providing the cabling assist functionality discussed below while remaining within the scope of the present disclosure as well.

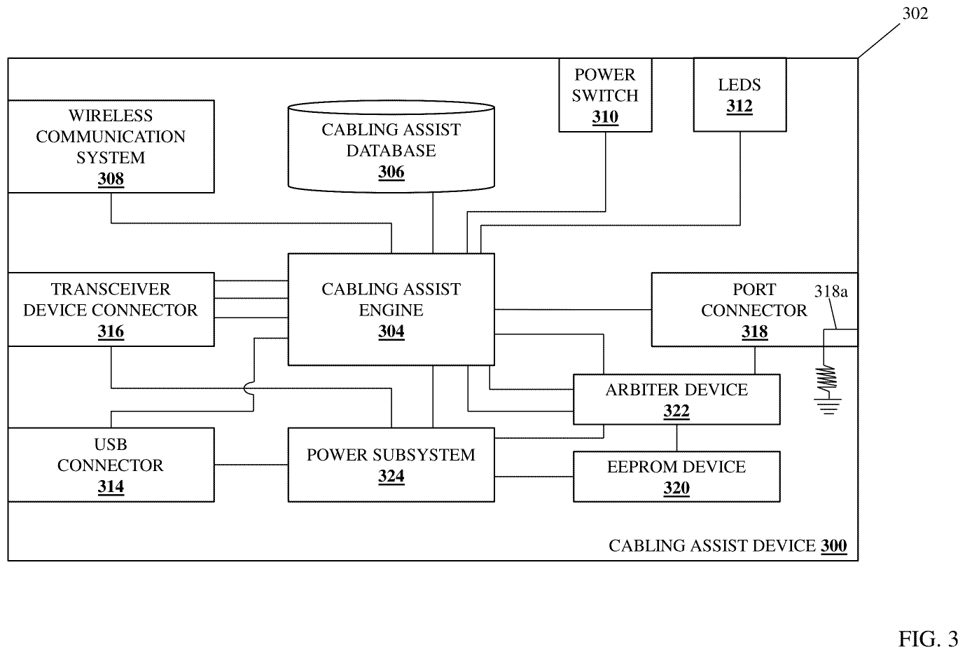

Referring now to FIG. 3, an embodiment of a cabling assist device 300 is illustrated that may provide the cabling assist device 200 discussed above with reference to FIGS. 2A-2C. In the illustrated embodiment, the cabling assist device 300 includes a chassis 302 that houses the components of the cabling assist device 300, only some of which are illustrated and described below. For example, the chassis 302 may house a processing system (not illustrated, but which may include the processor 102 discussed above with reference to FIG. 1 such as, for example, a System on Chip (SoC) processor) and a memory system (not illustrated, but which may include the memory 114 discussed above with reference to FIG. 1) that is coupled to the processing system and that includes instructions that, when executed by the processing system, cause the processing system to provide a cabling assist engine 304 that is configured to perform the functionality of the cabling assist engines, cabling assist subsystems, and/or cabling assist devices discussed below. To provide a specific example, the cabling assist engine 304 may be provided by processing firmware executing instructions stored on flash memory, Dynamic Random Access Memory (DRAM), and/or other memory subsystems known in the art.

The chassis 302 may also house a storage system (not illustrated, but which may include the storage 108 discussed above with reference to FIG. 1) that is coupled to the cabling assist engine 304 (e.g., via a coupling between the storage system and the processing system) and that includes a cabling assist database 306 that is configured to store any of the information utilized by the cabling engine 304 discussed below. The chassis 302 may also house a wireless communication system 308 that is coupled to the cabling assist engine 304 (e.g., via a coupling between the wireless communication system 308 and the processing system) and that may be provided by BLUETOOTH® Low Energy (BLE) components, Near Field Communication (NFC) components, WiFi components, and/or any other wireless communication components that would be apparent to one of skill in the art in possession of the present disclosure.

A power switch 310 may be provided on a surface of the chassis 302 and coupled to the cabling assist engine 304 (e.g., via a coupling between the power switch 310 and the processing system), and as discussed above for the power switch 210 of FIGS. 2A-2C, may be configured to activate and deactivate the cabling assist device 300. A plurality of Light Emitting Devices (LEDs) 312 may be provided on a surface of the chassis 302 and coupled to the cabling assist engine 304 (e.g., via a coupling between the LEDs 312 and the processing system), and as discussed above for the light emitting devices 212 of FIGS. 2A-2C, may include the power LED, the wireless indicator LED, the computing device activity LED, and the transceiver device activity LED discussed below, and/or any other LEDs that would be apparent to one of skill in the art in possession of the present disclosure.

A USB connector 314 may be provided on a surface of the chassis 302 and coupled to the cabling assist engine 304 (e.g., via a coupling between the USB connector 314 and the processing system), and as discussed above for the USB connector 214 of FIGS. 2A-2C, may be configured for use in providing power to the cabling assist device 300 (e.g., via its connection to a power source to power the cabling assist device 300 or charge a power subsystem included therein), enabling communications with the cabling assist device 300, and/or performing any other USB connector operations that would be apparent to one of skill in the art in possession of the present disclosure.

A transceiver device connector 316 is included on the chassis 302 and coupled to the cabling assist engine 304 (e.g., via a coupling between the transceiver device connector 316 and the processing system). For example, the transceiver device connector 316 may be coupled to the cabling assist engine 304 by an Inter-Integrated Circuit (I2C) connection that may include a Serial DAta (SDA) and Serial CLock (SCL) lines, a ModPresent (ModPrsL) connection to a GPIO input on the processing system, a Module Select/Module Reset/Low Power Mode (ModSel/Reset/LPMode) connection to GPIO outputs in the processing system, and/or any other connections that would be apparent to one of skill in the art in possession of the present disclosure. In an embodiment, the I2C connection from the cabling assist engine 304 to the transceiver device connector 316 may be configured to allow the cabling assist engine 304 to read and write to a transceiver device that is connected to the transceiver device connector 316. Similarly as discussed above for the transceiver device connector 206, the transceiver device connector 316 may include a QSFP transceiver connector for a QSFP transceiver device, although a variety of other types of transceiver connectors (e.g., QSFP-DD transceiver connectors, OSFP transceiver connectors, SFP+ transceiver connectors, etc.) will fall within the scope of the present disclosure as well.

A port connector 318 is included on the chassis 302 and coupled to the cabling assist engine 304 (e.g., via a coupling between the port connector 318 and the processing system). For example, the port connector 318 may be coupled to the cabling assist engine 304 by a Module Select (ModSel) connection to a General Purpose Input/Output (GPIO) input on the processing system, and/or any other connections that would be apparent to one of skill in the art in possession of the present disclosure. Similarly as discussed above for the port connector 204, the port connector 318 may be provided by a module card edge connector that is configured to connect to a QSFP transceiver port connector on a switch device, although one of skill in the art in possession of the present disclosure will appreciate how a variety of other types of port connectors (e.g., QSFP Double Density (QSFP-DD) port connectors, Octal Small Form-factor Pluggable (OSFP) port connectors, enhanced Small Form-factor Pluggable (SFP+) port connectors etc.) for connection to other types of computing devices (e.g., server devices, storage systems, etc.) will fall within the scope of the present disclosure as well. As illustrated, the port connector 318 may include a Module Present (ModPrsL) line 318a that, as discussed below, is configured for use by a computing device to detect the connection of the cabling assist device 300 to one of its ports.

In the embodiments illustrated and described below, an Electronically Erasable Programmable Read-Only Memory (EEPROM) device 302 is housed in the chassis 302, and an arbiter device 322 (e.g., a 2:1 I2C arbiter device) is coupled to the EEPROM device 320, the port connector 318 (e.g., via an I2C connection having SDA and SCL lines similarly as discussed above), and the cabling assist engine 304 (e.g., via an I2C connection and a pair of interrupt lines (INT0 and INT1) to the processing system). As described below, both the cabling assist engine 304 and operating systems in computing devices to which the cabling assist device 300 is connected via the port connector 318 (e.g., a Networking Operating System (NOS) in a switch device, an Operating System (OS) in a Baseboard Management Controller (BMC) device, etc.) may be configured to access the EEPROM device 320 (e.g., at a transceiver address “0x50”) via the arbiter device 322. However, while the EEPROM device 320 and the arbiter device 322 are illustrated as separate from the cabling assist engine 304, one of skill in the art in possession of the present disclosure will appreciate how the processing system that provides the cabling assist engine 304 may include “built-in” I2C target functionality and may be configured to emulate an EEPROM device, and thus the arbiter device 322 and the EEPROM device 320 may be integrated into or otherwise included in the cabling assist engine 304.

As illustrated, a power subsystem 324 is housed in the chassis and coupled to the cabling assist engine 304 (e.g., via a Vcc/ground connection between the power subsystem 324 and the processing system), the USB connector 314 (e.g., to allow the charging of the power subsystem 324), the transceiver device connector 316 (e.g., via a VCC/ground connection and a DC/DC voltage regulator between the power subsystem and the transceiver device connector 316), the EEPROM device 320 (e.g., via a Vcc/ground connection between the power subsystem 324 and the EEPROM device 320), and the arbiter device 322 (e.g., via a Vcc/ground connection between the power subsystem 324 and the arbiter device 322). In the examples below, the power subsystem 324 may include a battery (e.g., a rechargeable Lithium battery) that may be configured to power the cabling assist engine 304, a transceiver device connected to the transceiver device connector 316, the EEPROM device 320/arbiter device 322, and/or other components of the cabling assist device 300, although other power subsystems will fall within the scope of the present disclosure well.

However, while a specific cabling assist device 200 has been illustrated and described, one of skill in the art in possession of the present disclosure will recognize that the cabling assist device of the present disclosure may include a variety of components and component configurations for providing the cabling assist functionality discussed below while remaining within the scope of the present disclosure as well.

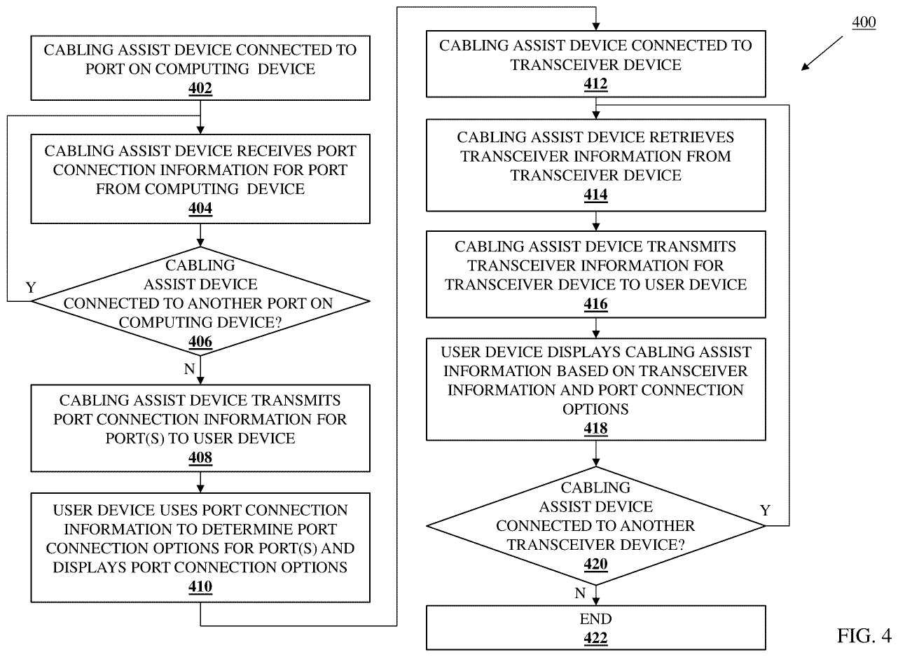

Referring now to FIG. 4, an embodiment of a method 400 for assisting with the cabling of computing devices is illustrated. As discussed below, the systems and methods of the present disclosure provide a cabling assist device that is configured to connect to and collect port information for port(s) that are to-be cabled together, provide that port information to a user device so that it may display port connection options for those port(s), and then connect to and collect transceiver information from a transceiver, and provide that transceiver information to the user device so that is may display cabling assist information based on that transceiver information and the port connection options. For example, the cabling assist system of the present disclosure may include a user device, a computing device including a port, and a cabling assist device that includes a port connector and a transceiver device connector. The cabling assist device connects to the port included on the computing device via the port connector, receives port connection information for the port from the computing device, and transmits the port connection information to the user device. The user device determines port connection options for the port using the port connection information, and displays the port connection options. The cabling assist device then connects to a transceiver device via the transceiver device connector, retrieves transceiver information from the transceiver device, and transmits the transceiver information to the user device. The user device then determines that the transceiver information corresponds to a first of the port connection options, and identifies the first of the port connection options that are being displayed. As such, users may be assisted in cabling ports together to prevent many of the issues with conventional fabric connection systems discussed above.

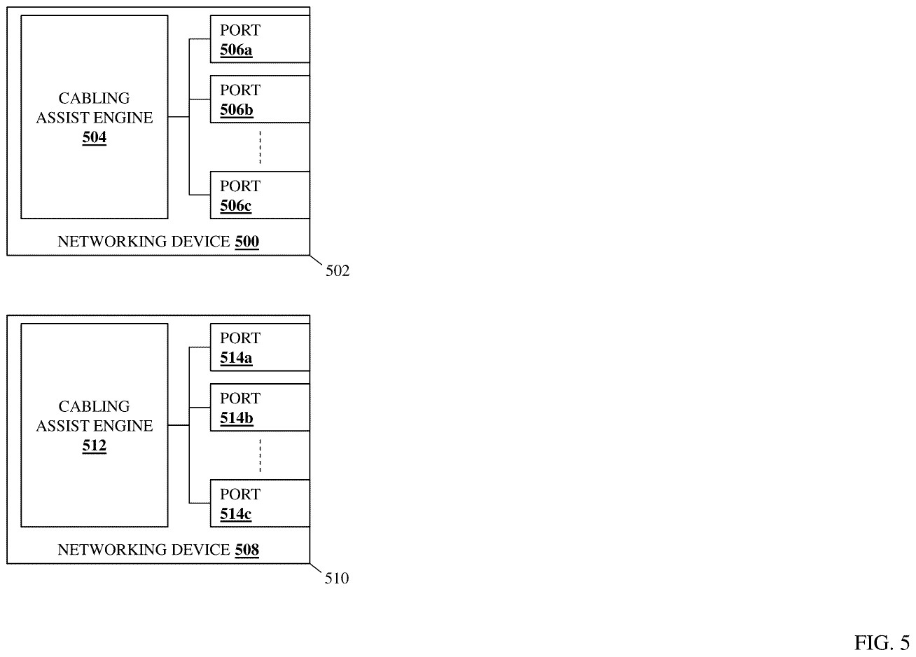

With reference to FIG. 5, an embodiment of computing devices that may be used with the cabling assist system of the present disclosure is illustrated. In the examples provided below, the computing devices used with the cabling assist system are provided by a pair of networking devices that are illustrated and described as being provided by switch devices, but one of skill in the art in possession of the present disclosure will appreciate how server devices, storage systems, and/or other computing devices that operate similarly to the networking devices discussed below may be used with the cabling assist system while remaining within the scope of the present disclosure as well.

FIG. 5 illustrates a networking device 500 that includes a chassis 502 that houses the components of the networking device 500, only some of which are illustrated and described below. For example, the chassis 502 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a cabling assist engine 504 that is configured to perform the functionality of the cabling assist engines, cabling assist subsystems, and/or networking devices discussed below. In specific examples, the cabling assist engine 504 may be provided by a Networking Operating System (NOS), an Operating System (OS) in a Baseboard Management Controller (BMC) device included in the networking device 500, and/or via other techniques that would be apparent to one of skill in the art in possession of the present disclosure. A plurality of ports 506a, 506b, and up to 506c are accessible on the chassis 502 and coupled to the cabling assist engine 504 (e.g., via a coupling between the ports 506a-506c and the processing system), and in the specific examples below are provided by QSFP transceiver ports, but one of skill in the art in possession of the present disclosure will appreciate how other type of ports will fall within the scope of the present disclosure as well.

FIG. 5 also illustrates a networking device 508 that includes a chassis 510 that houses the components of the networking device 508, only some of which are illustrated and described below. For example, the chassis 510 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a cabling assist engine 512 that is configured to perform the functionality of the cabling assist engines, cabling assist subsystems, and/or networking devices discussed below. In specific examples, the cabling assist engine 512 may be provided by a NOS, an OS in a BMC device included in the networking device 508, and/or via other techniques that would be apparent to one of skill in the art in possession of the present disclosure. A plurality of ports 514a, 514b, and up to 514c are accessible on the chassis 510 and coupled to the cabling assist engine 512 (e.g., via a coupling between the ports 514a-514c and the processing system), and in the specific examples below are provided by QSFP transceiver ports, but one of skill in the art in possession of the present disclosure will appreciate how other type of ports will fall within the scope of the present disclosure as well.

However, while two specific networking devices are illustrated and described below as being used in the cabling assist system of the present disclosure, one of skill in the art in possession of the present disclosure will appreciate how the networking devices 500 and 502 may include a variety of components and/or component configurations in order to perform conventional networking functionality, as well as the cabling assist functionality described below, while remaining within the scope of the present disclosure.

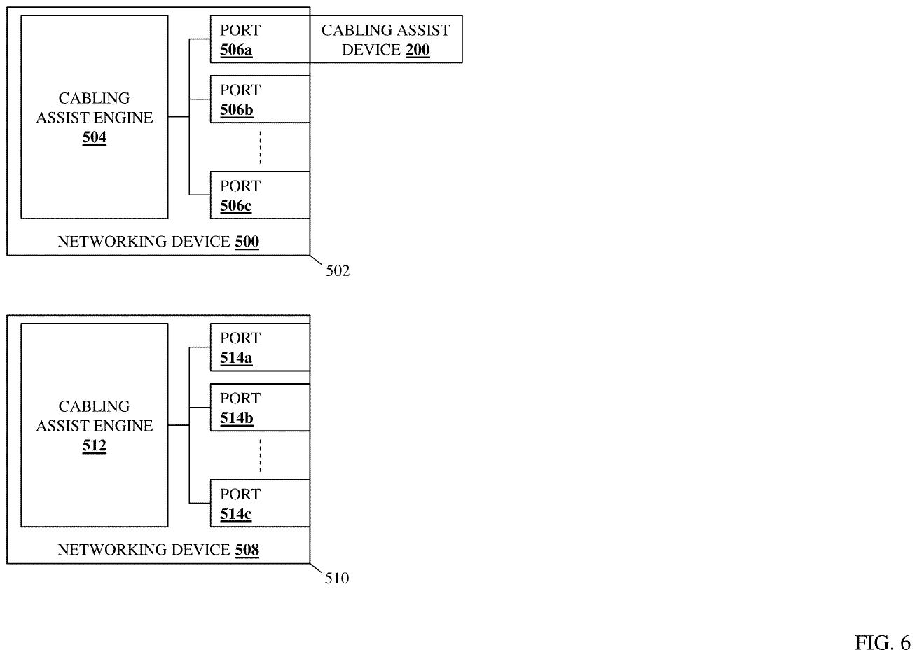

The method 400 begins at block 402 where a cabling assist device is connected to a port on a computing device. With reference to FIGS. 2A-2C and 6, in an embodiment of block 402, a user may connect the port connector 204 on the cabling assist device 200 to the port 506a on the networking device 500. For example, the user may utilize the user device discussed below to retrieve (e.g., via a management network) and display a “job sheet” that identifies the port 506a on the networking device 500 for connection to at least one other port (e.g., the ports 514a and 514b on the networking device 508 in one of the examples provided below) and, in response, may activate the cabling assist device 200 using the power switch 210. The user may then position the cabling assist device 200 adjacent the port 506a on the networking device 200 such that the port connector 204 is located immediately adjacent the port 506a, and then move the cabling assist device 200 towards the port 506a so that the port connector 204 engages with port 506a in a manner that one of skill in the art in possession of the present disclosure will recognize communicatively connects the cabling assist device 200 to the cabling assist engine 504 in the networking device 500 via its port 506a. Furthermore, while the cabling assist device 200 is illustrated and described as being connected to the port 506a, one of skill in the art in possession of the present disclosure will appreciate how the cabling assist device 200 may be connected to any of the other ports 506b-506c on the networking device 500, or any of the ports 514a-514c on the networking device 508, similarly as described above for the port 506a.

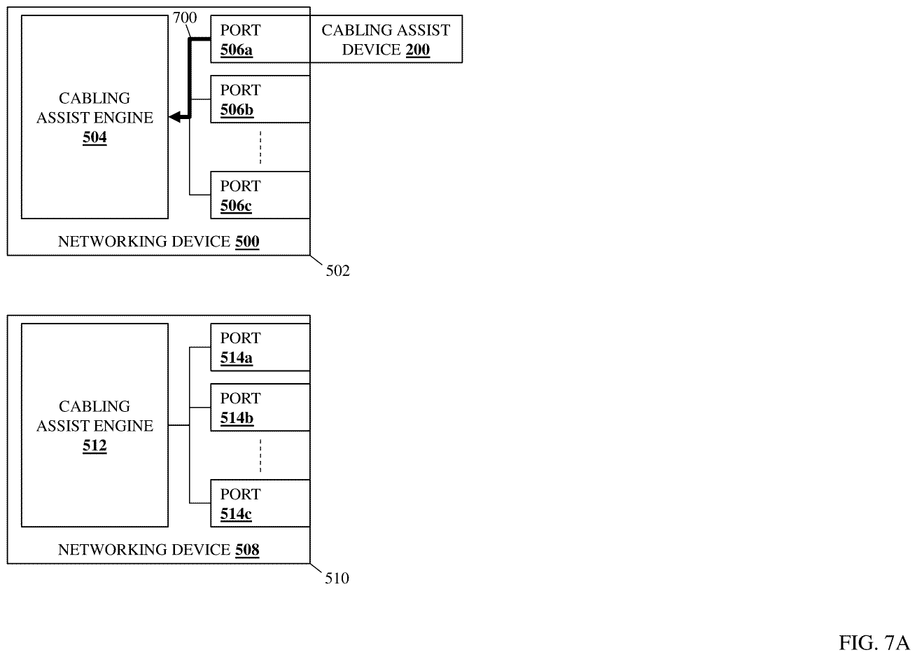

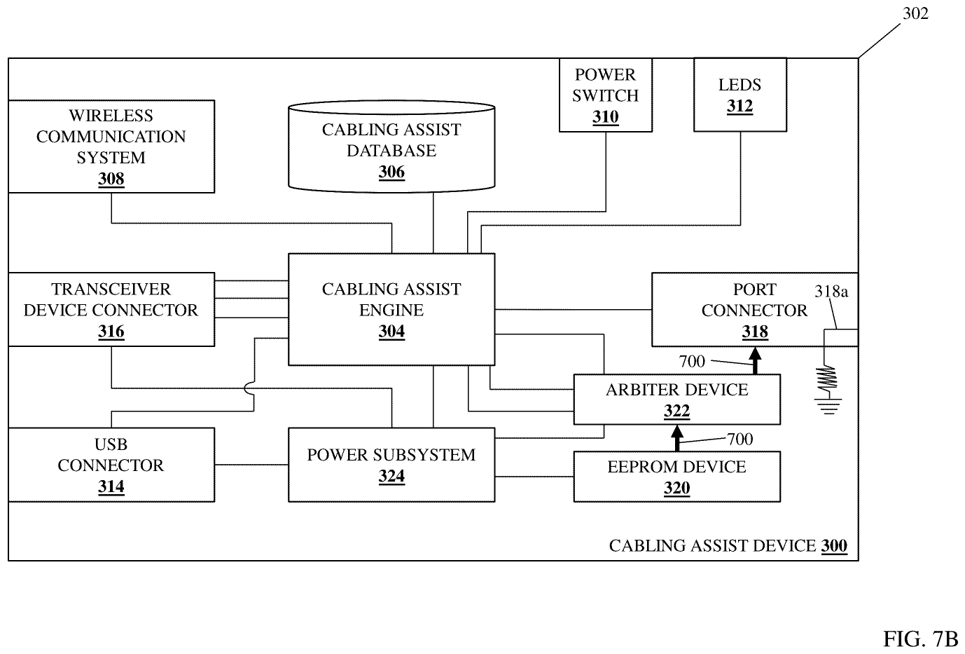

The method 400 then proceeds to block 404 where the cabling assist device receives port connection information for the port from the computing device. With reference to FIGS. 7A and 7B, in an embodiment of block 404, the cabling assist engine 504 in the networking device 500 may perform cabling assist device identification operations 700 that include retrieving cabling assist device information from the EEPROM device 320 in the cabling assist device 200/300 via the port connector 318 and the port 506a on the networking device 500. For example, in response to the connection of the cabling assist device 200/300 to the port 506a on the networking device 500, the cabling assist engine 504 in the networking device 500 (a NOS, BMC OS, etc.) will detect that a device has been connected to the port 506a (e.g., via the Module Present (ModPrsL) line 318a in the cabling assist device 200/300), and will perform the cabling assist device identification operations 700 to read the cabling assist device information from the EEPROM device 320 (e.g., from I2C address 0x50).

As will be appreciated by one of skill in the art in possession of the present disclosure, the cabling assist device information may be configured to identify to the cabling assist engine 504 that a cabling assist device (i.e., rather than a conventional transceiver device) has been connected to the port 506a, and thus the cabling assist engine 504 may identify the cabling assist device 200/300 at block 404. Furthermore, while the cabling assist device identification operations 700 are illustrated as being performed via the arbiter device 322, the cabling assist engine 504 in the networking device 500 may have default access to the EEPROM device 320 in the cabling assist device 200, and thus arbitration operations by the arbiter device 322 may not be performed at block 404. However, while a specific example of the identification of the cabling assist device 300 by the computing device to which it is connected has been described, one of skill in the art in possession of the present disclosure will appreciate how a computing device may identify a connected cabling assist device 200 using other techniques that will fall within the scope of the present disclosure as well.

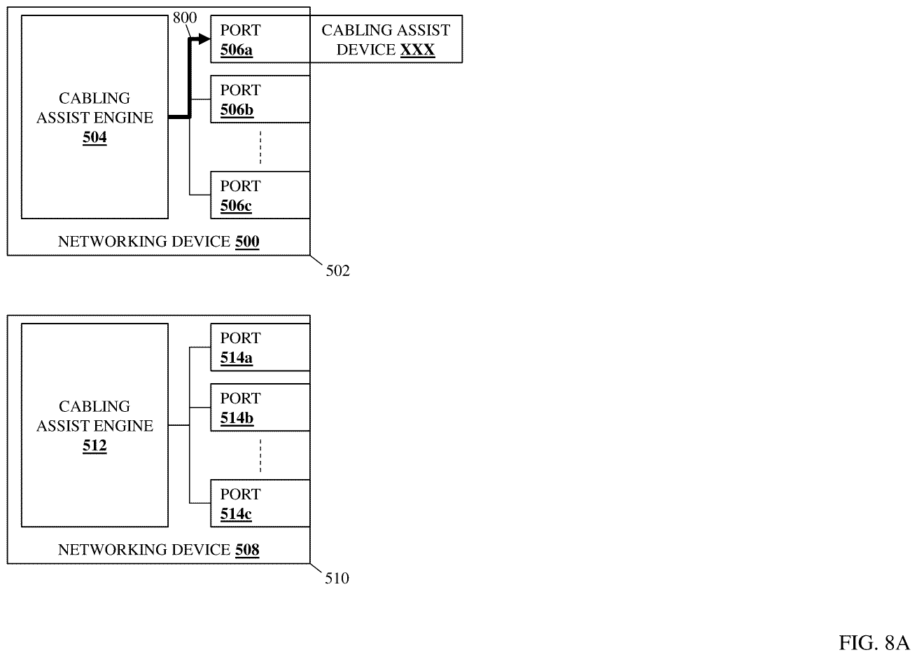

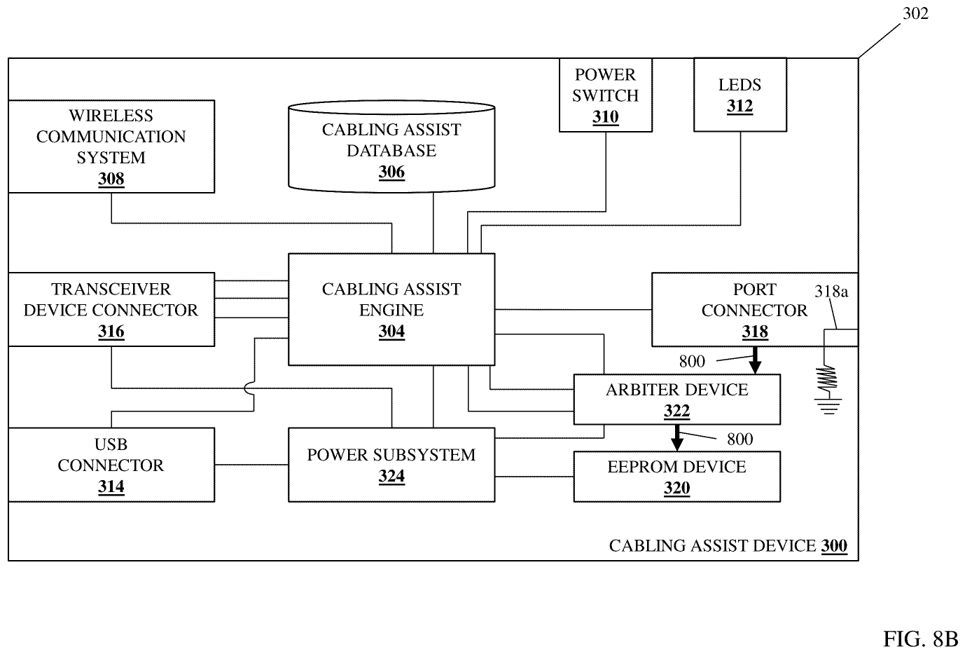

With reference to FIGS. 8A and 8B, in an embodiment of block 404, the cabling assist engine 504 in the networking device 500 may perform port connection information provisioning operations 800 that include providing port connection information in the EEPROM device 320 in the cabling assist device 200/300 via the port connector 318 and the port 506a on the networking device 500. For example, in response to the identifying that the cabling assist device 200/300 has been connected to the port 506a on the networking device 500, the cabling assist engine 504 in the networking device 500 (a NOS, BMC OS, etc.) will perform the port connection information provisioning operations 800 to write the port connection information to a ring buffer in the EEPROM device 320.

In an embodiment, the port connection information may include a networking device identifier for the networking device 500 (e.g., a switch hostname), a port identifier for the port 506a (e.g., a port number), a port configuration for the port 506a (e.g., a port speed, a port auto-negotiation setting, a port Forward Error Correction (FEC) setting, and/or any other port configuration information that would be apparent to one of skill in the art in possession of the present disclosure\), transceiver device identifier(s) for transceiver device(s) that are configured to operate with the port 506a (e.g., a prioritized list of transceivers devices that are compatible with the port configuration of the port 506a that may include preferred transceiver identifiers (e.g., serial numbers) for preferred transceiver devices that have been qualified for use with the networking device 500 and the port 506a (e.g., by a networking device provider), transceiver type identifiers for types of transceiver devices that the networking device 500 and the port 560a are configured to operate with, and/or any other transceiver device identifiers that would be apparent to one of skill in the art in possession of the present disclosure), and/or any other port connection information (e.g. the rack identifier for a rack in which the networking device 500 is located) that one of skill in the art in possession of the present disclosure would recognize as providing the functionality described below.

Similarly as discussed above, while the cabling assist device identification operations 700 are illustrated as being performed via the arbiter device 322, the cabling assist engine 504 in the networking device 500 may have default access to the EEPROM device 320 in the cabling assist device 200, and thus arbitration operations by the arbiter device 322 may not be performed at block 404. However, while a specific example of providing port connection information to the cabling assist device 300 by the computing device to which it is connected has been described, one of skill in the art in possession of the present disclosure will appreciate how a computing device may provide a variety of port connection information to a connected cabling assist device 200 using other techniques that will fall within the scope of the present disclosure as well.

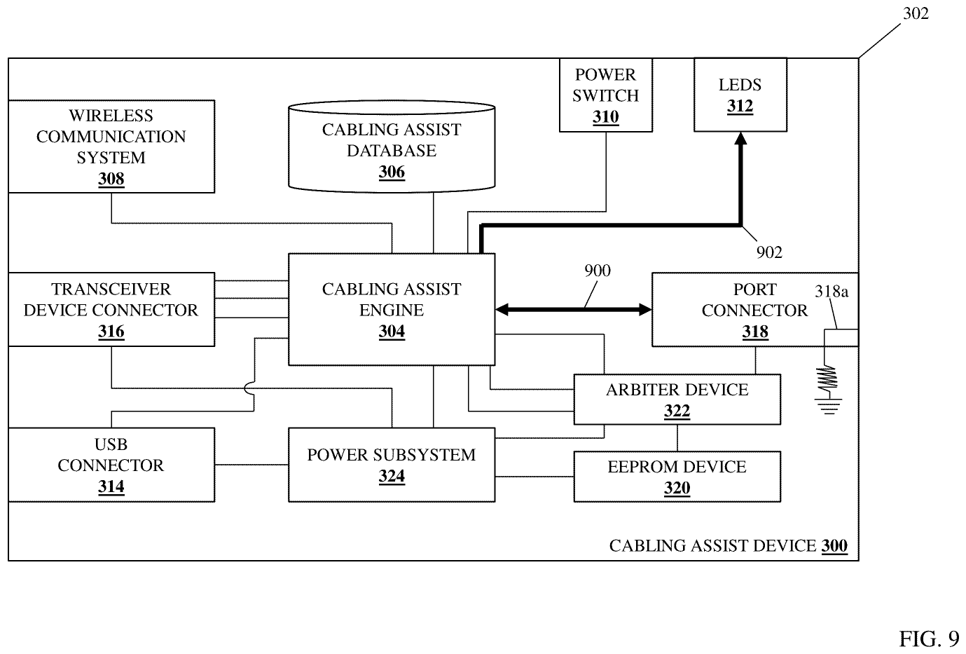

With reference to FIG. 9, the cabling assist engine 304 in the cabling assist device 200/300 may perform port connection information provisioning monitoring operations 900 that include monitoring (e.g., via the Module Select (ModSel) line) the provisioning of the port connection information in the EEPROM device 320 by the cabling assist engine 504 in the networking device 500 to determine when the cabling assist engine 504 has finished providing the port connection information in the EEPROM device 320. In response to determining that the cabling assist engine 504 has finished providing the port connection information in the EEPROM device 320, the cabling assist device 200/300 may perform LED activation operations 902 that include activating the LEDs 312 (e.g., the computing device activity LED discussed above) to indicate that the provisioning of the port connection information has completed, which may in turn indicate to the user that they may disconnect the cabling assist device 200/300 from the port 506a on the networking device 500.

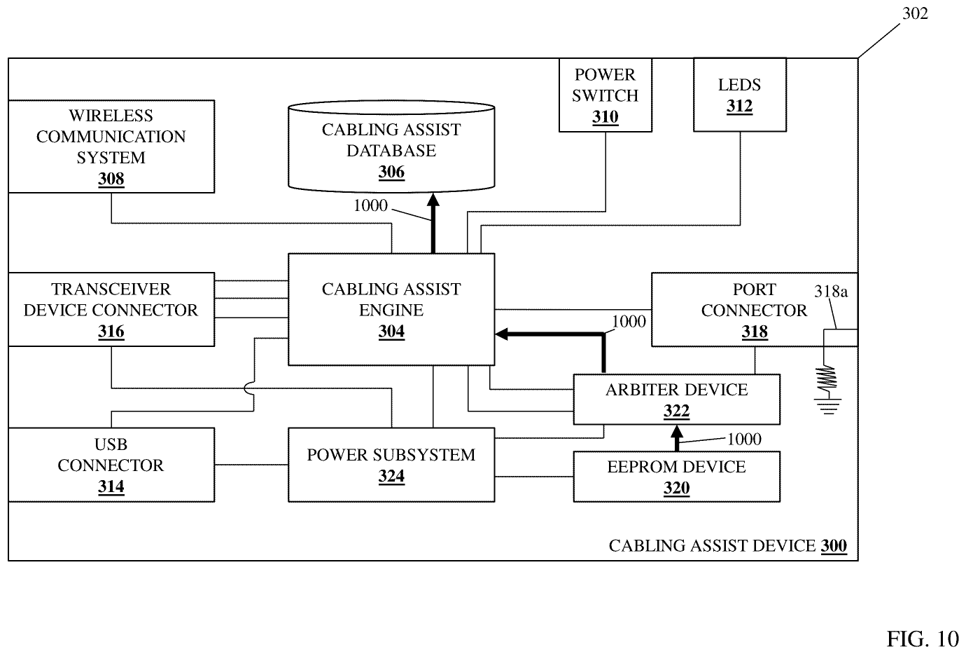

With reference to FIG. 10, following the completion of the provisioning of the port connection information in the EEPROM device 320 by the cabling assist engine 504 in the networking device 500, the cabling assist engine 304 in the cabling assist device 200/300 may perform port connection information storage operations 1000 that include retrieving the port connection information from the EEPROM device 320 and storing it in the cabling assist database 306. As will be appreciated by one of skill in the art in possession of the present disclosure, the port connection information storage operations 1000 may include the cabling assist engine 304 using the arbiter device 322 to arbitrate for control of the EEPROM device 320 from the cabling assist engine 504 in the networking device 500 so that it may retrieve the port connection information from the EEPROM device 320.

The method 400 then proceeds to decision block 406 where the method 400 proceeds depending on whether the cabling assist device is connected to another port on a computing device. In the embodiment discussed first below, the cabling assist device 200 is disconnected from the port 506a on the networking device 500 and used with the cabling assist system of the present disclosure to cable the port 506a (i.e., select a transceiver and/or cable for connection to the port 506a) for connection to another port (which may be cabled using the cable assist device 200 similarly as described for the port 506a). However, as discussed in further detail below, in some embodiments the cabling assist device 200 may be disconnected from the port 506a and connected to any other port(s) that the port 506a will be cabled to, which allows a user to select a cabling system for cabling multiple ports together in consideration of each of those ports.

If, at decision block 406, the cabling assist device is connected to another port on a computing device, the method 400 returns to block 404. As such, the method 400 may loop such that the cabling assist device 200 is connected to multiple ports that are to-be cabled together (e.g., as identified by the job sheet displayed on the user device discussed above), and corresponding port connection information is received for each of those ports by the cabling assist device 200 similarly as described above for the port 506a on the networking device 500.

If, at decision block 406, the cabling assist device is not connected to another port on a computing device, the method 400 proceeds to block 408 where the cabling assist device transmits port connection information for the port(s) to a user device. In the embodiments illustrated and described below, the cabling assist device 200 has been disconnected from the port 506a on the networking device 500 which, as discussed above, may be performed by a user following the activation of one of the LEDs 212/312 on the cabling assist device 200/300. However, one of skill in the art in possession of the present disclosure will appreciate how the cabling assist device 200/300 may operate similarly as described below while connected to the port 506b.

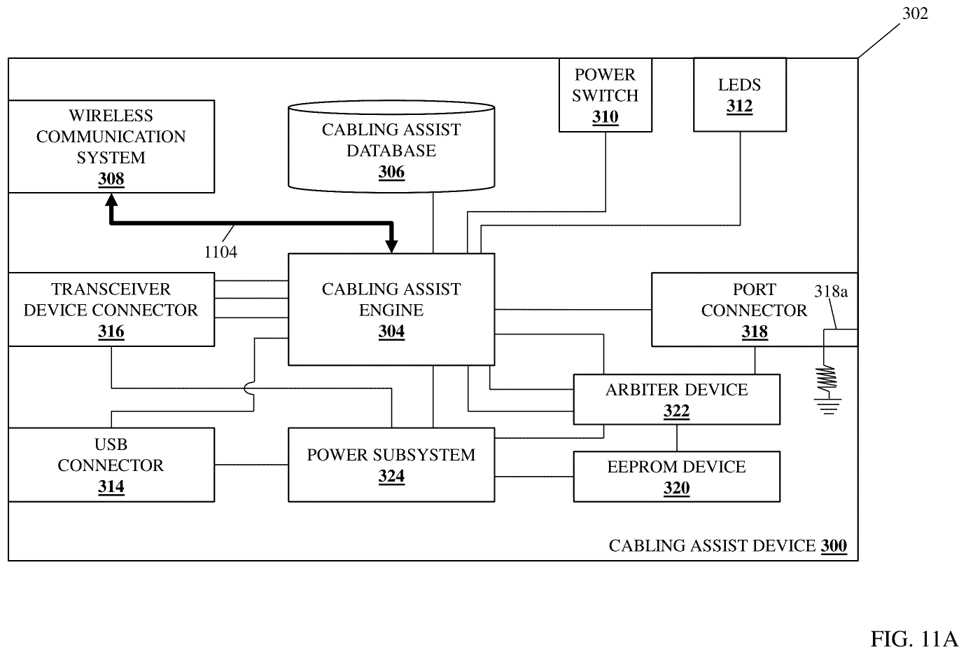

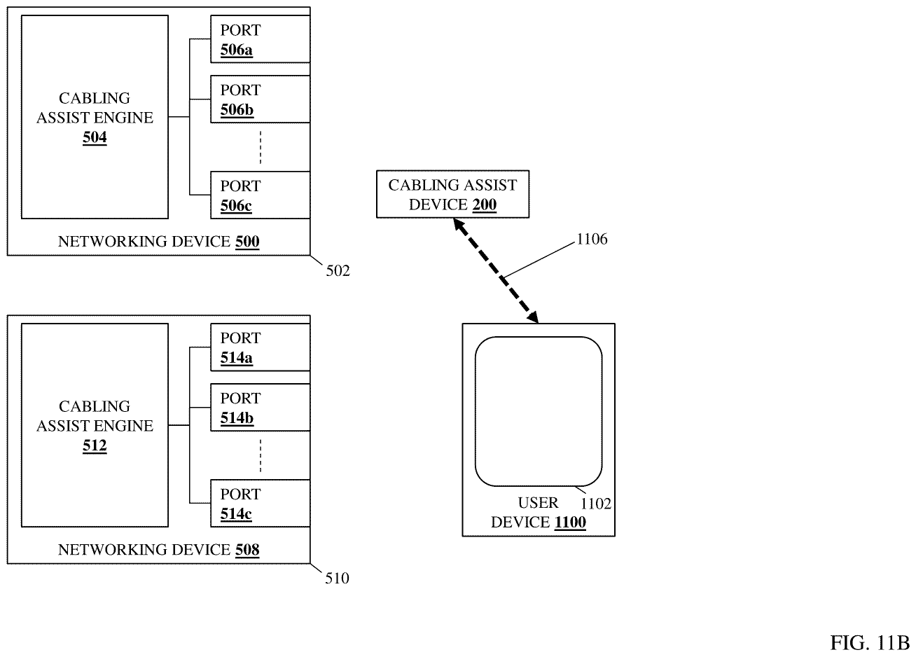

With reference to FIG. 11B, the user of the cabling assist device 200 may provide a user device 1100 that is configured to operate with the cabling assist device 200 via a cabling assist application (discussed in further detail below). For example, one of the inventors of the present disclosure described a fabric connection assist system in U.S. Pat. No. 11,567,819, attorney docket no. 123542.01, filed on Apr. 16, 2021, which include a mobile device with a fabric connection assist application that may provide the user device 1100 and cabling assist application described herein. The user device 1100 includes a display device 1102 that may display information via the cabling assist application described below, and while one of skill in the art in possession of the present disclosure will recognize that the user device 1100 is illustrated and described as being provided by a mobile phone, the user device 1100 may be provided by any computing devices (e.g., laptop/notebook computing devices, tablet computing devices, Augmented Reality (AR) headset computing devices, etc.) that are configured to interact with the cabling assist device 200 and display information like that described below while remaining within the scope of the present disclosure as well.

With reference to FIGS. 11A and 11B, in an embodiment and during or prior to the method 400, the cabling assist engine 304 in the cabling assist device 200/300 may perform wireless communication establishment operations 1104 that include using the wireless communication system 308 to establish a wireless communication link 1106 with the user device 1100 that may be used to perform any of the wireless communications described below between the cabling assist device 200 and the user device 1100-. For example, the wireless communication establishment operations 1104 may include a user instructing the cabling assist device 200/300 and/or the user device 1100 to utilize BLE wireless communications systems in the cabling assist device 200 and the user device 1100 to “pair” the cabling assist device 200 and the user device 1100 and establish a BLE wireless communication link, although other wireless technologies and wireless communication link establishment techniques will fall within the scope of the present disclosure as well. Furthermore, while the establishment of wireless communications has been described, one of skill in the art in possession of the present disclosure will appreciate how a wired communication link may be provided between the cabling assist device 200/300 and the user device 1100 using, for example, a USB “On The Go” (OTG) cable connected to the USB connector 214 on the cabling assist device 200/300 and a USB connector on the user device 1100.

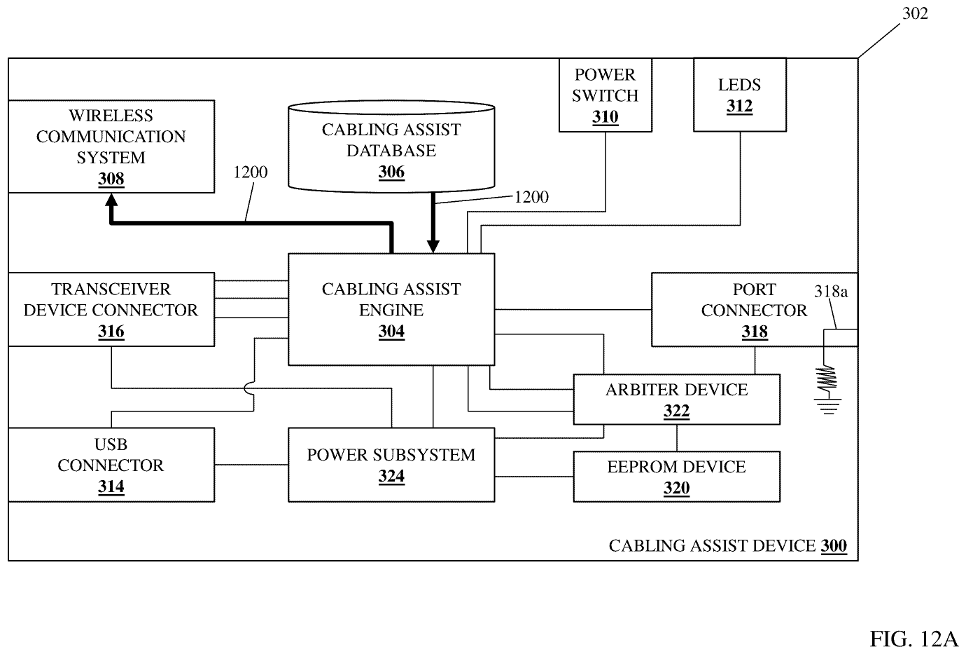

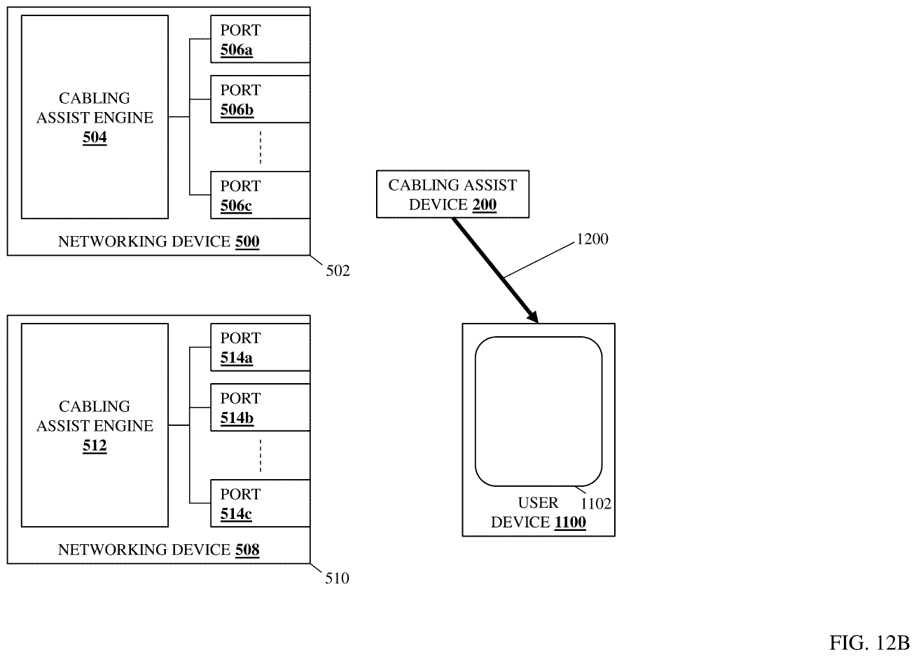

With reference to FIGS. 12A and 12B, in an embodiment of block 408, the cabling assist engine 304 in the cabling assist device 200/300 may perform port connection information provisioning operations 1200 that includes retrieving the port connection information that was stored in the cabling assist database 306 as described above, and using the wireless communication system 308 to transmit that port connection information via the wireless communication link 1106 and to the user device 1100.

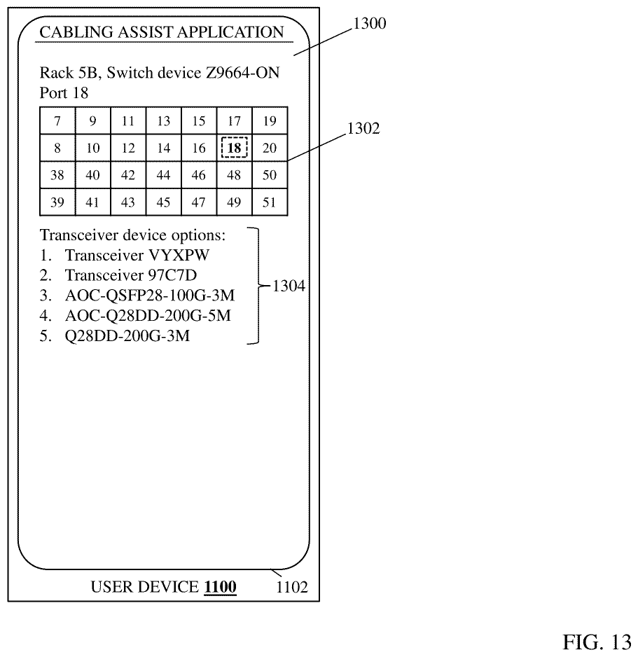

The method 400 then proceeds to block 410 where the user device uses the port connection information to determine port connection options for the port(s) and displays the port connection options. With reference to FIG. 13, in an embodiment of block 410, the user device 1100 may use the port connection information received from the cabling assist device 200 at block 408 to generate a cabling assist screen 1300 via a cabling assist application running on the user device 1100. As can be seen in FIG. 13, the cabling assist screen 1300 includes a rack identifier (e.g., “Rack 5B”) that was included in the port connection information and that identifies a rack in which the networking device 500 is located, a networking device identifier (e.g., “Switch device Z9664-ON”) that was included in the port connection information and that identifies the networking device 500, a port identifier (e.g., “Port 18”) that was included in the port connection information and that identifies the port 506a on the networking device 500. Furthermore, the cabling assist screen 1300 also include a networking device port graphic 1302 that provides a graphical physical layout of a subset of the ports 506a-506c on the networking device 500, with the port 506a identified in the networking device port graphic 1302 (e.g., via the bolded “18” that is surrounded by a dashed square in the illustrated example).

Further still, the cabling assist screen 1300 also includes a port connection options section 1304 that, in the illustrated examples, includes a prioritized list of transceivers devices that was included in the port connection information and that identifies transceiver devices that are compatible with the port configuration of the port 506a and that are identified by preferred transceiver identifiers (e.g., serial numbers) for preferred transceiver devices that have been qualified (e.g., by a networking device provider) for use with the networking device 500 and the port 506a (e.g., “1. Transceiver VYXPW, 2. Transceiver 97C7D, 3. AOC-QSFP 28-100G-3M, 4. AOC-Q28DD-200G-5M”), and by a transceiver type identifier for a type of transceiver device that the networking device 500 and the port 560a are configured to operate with (e.g., “5. Q28DD-200G-3M”). However, while a specific example of port connection options including a specific prioritized list of transceiver devices has been illustrated and described, one of skill in the art in possession of the present disclosure will appreciate how the port connection options displayed on the user device may identify any of a variety of port connection components and or port connection details (e.g., cable length(s) required to cable ports together, etc.) that would be apparent to one of skill in the art in possession of the present disclosure.

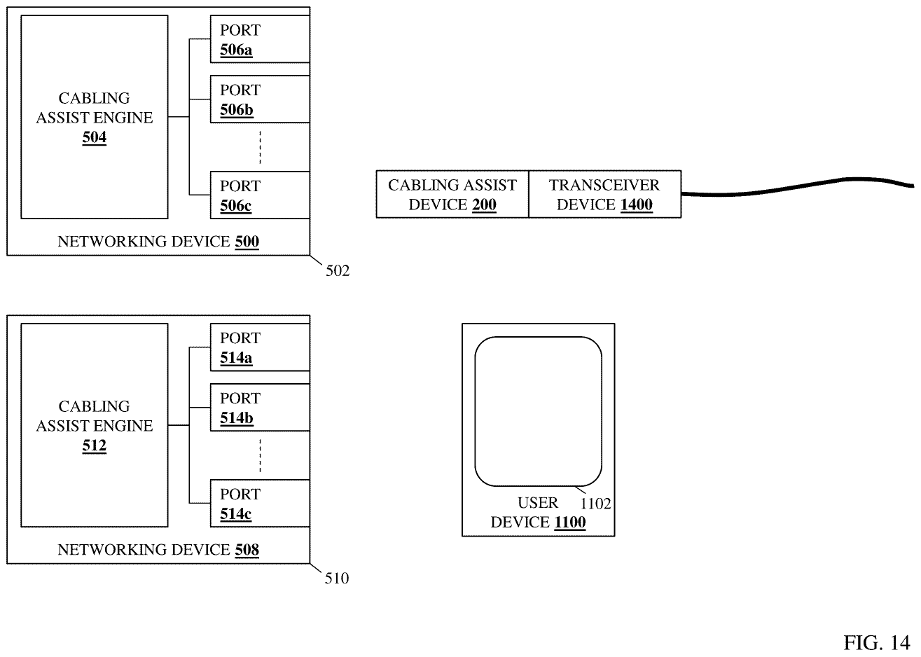

The method 400 then proceeds to block 412 where the cabling assist device is connected to a transceiver device. With reference to FIGS. 2A-2C and 14, in an embodiment of block 412, a transceiver device 1400 may be connected to the transceiver device connector 206 on the cabling assist device 200, and while the transceiver device 1400 is illustrated as including an integrated cable (e.g., as provided by Active Optical Cables (AOCs) and Direct Attach Cables (DACs)), the use of transceiver devices without integrated cables will fall within the scope of the present disclosure as well. For example, the user may select the transceiver device 1400 from a transceiver device inventory for connection to the port 506a on the networking device 500, and one of skill in the art in possession of the present disclosure will appreciate how the user may select the transceiver device 1400 from the port connection options (e.g., the prioritized list of transceiver devices) included on the cabling assist screen 1300 displayed on the user device 1100 (although one of skill in the art in possession of the present disclosure will recognize how the selection of the transceiver device 1400 by the user may not involve using the port connection options included on the cabling assist screen 1300 displayed on the user device 1100 in many embodiments). The user may then position the transceiver device 1400 adjacent the transceiver device connector 206 on the cabling assist device 200, and then move the transceiver device 1400 towards the cabling assist device 200 such that the transceiver device 1400 engages the transceiver device connector 206 on the cabling assist device 200.

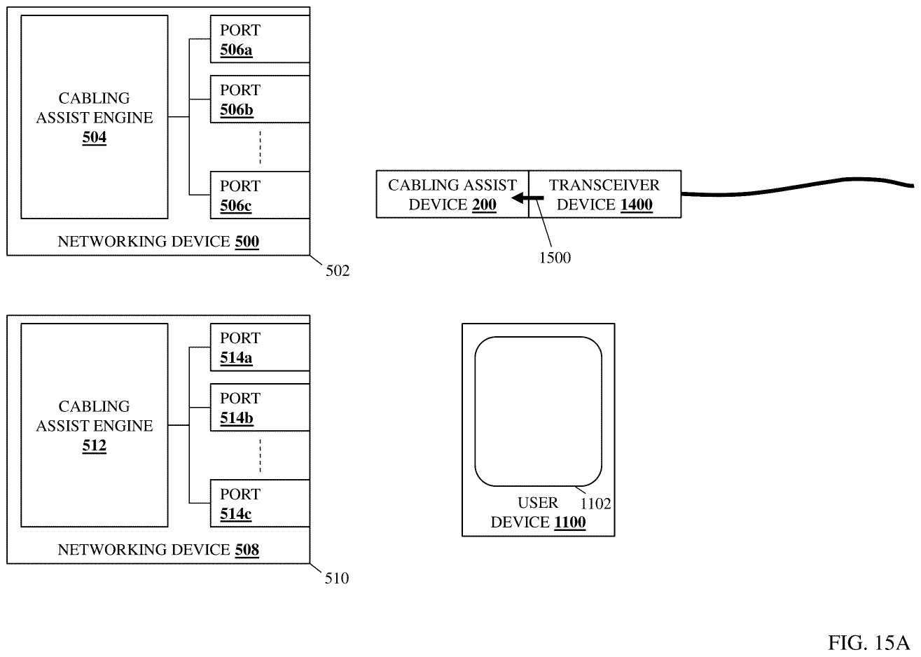

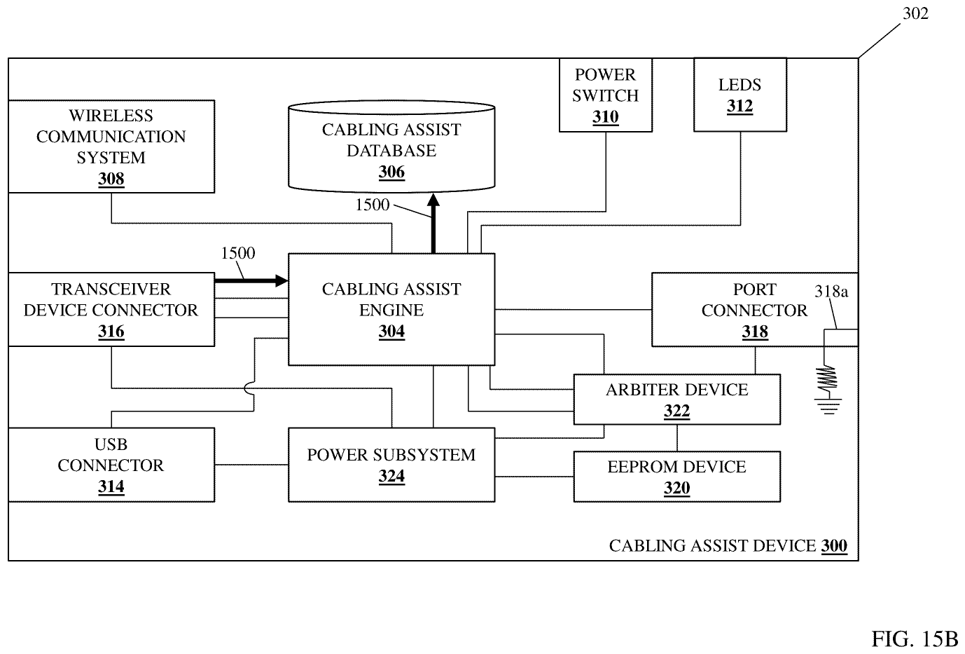

The method 400 then proceeds to block 414 where the cabling assist device retrieves transceiver information from the transceiver device. With reference to FIGS. 15A and 15B, in an embodiment of block 414, the cabling assist engine 304 in the cabling assist device 200/300 may perform transceiver information retrieval operations 1500 that include retrieving transceiver information from the transceiver device 1400 via the transceiver device connector 316, and storing that transceiver information in the cabling assist database 306. For example, at block 414, the cabling assist engine 304 in the cabling assist device 200/300 may detect the connection of the transceiver device 200/300 to the transceiver device connector 316 (e.g., via a Module Present (ModPrsL) line similarly as described above) and, in response, may read the transceiver information from an EEPROM device in the transceiver device 1400 (e.g., address “0x50” in the EEPROM device in the transceiver device 1400) via the transceiver device connector 316 and I2C connections, and then write that transceiver information to the cabling assist database 306.

In an embodiment, the transceiver information retrieved from the transceiver device 1400 may include a cable length of a cable integrated with the transceiver device 1400, a connector type of a connector on the transceiver device 1400, a date associated with the transceiver device 1400, a display name for the transceiver device 1400, a form-factor for the transceiver device 1400, a high power identifier for the transceiver device 1400, a maximum transceiver device power for the transceiver device 1400, a maximum port power for a port connected to the transceiver device 1400, a media lockdown state for the transceiver device 1400, a qualification indicator for the transceiver device 1400, revision compliance information for the transceiver device 1400, a vendor of the transceiver device 1400, a vendor Organizationally Unique Identifier (OUI) for the transceiver device 1400, a serial number for the transceiver device 1400, a vendor part number for the transceiver device 1400, a vendor revision for the transceiver device 1400, and/or any other transceiver information that would be apparent to one of skill in the art in possession of the present disclosure.

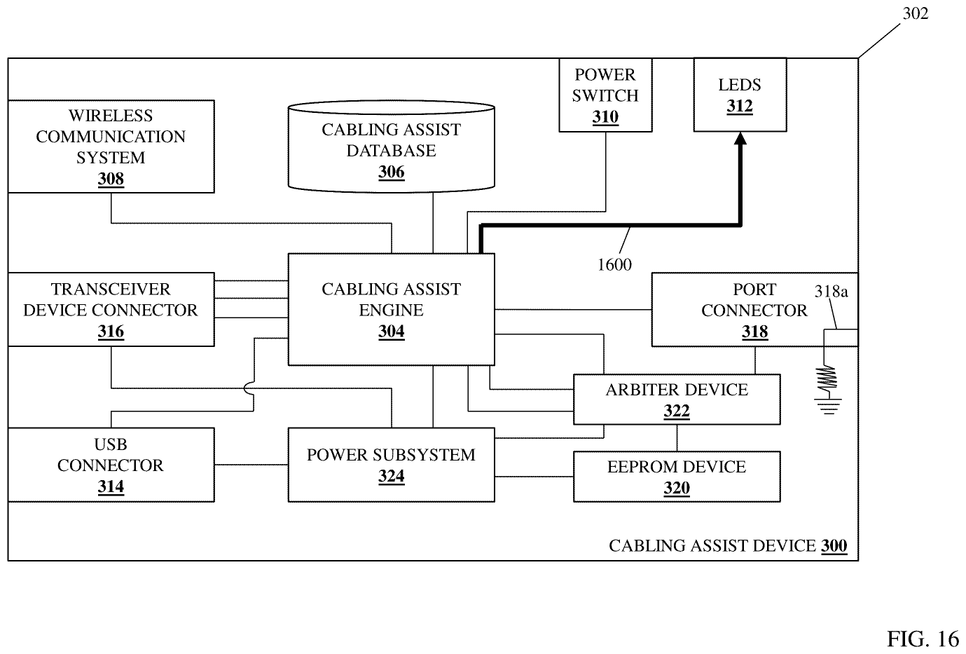

With reference to FIG. 16, in response to completing the retrieval of the transceiver information, the cabling assist device 200/300 may perform LED activation operations 1600 that include activating the LEDs 312 (e.g., the transceiver device activity LED discussed above) to indicate that the retrieval of the transceiver information has completed, which may indicate to the user that they may disconnect the transceiver device 1400 from the cabling assist device 200/300.

The method 400 then proceeds to block 416 where the cabling assist device transmits the transceiver information for the transceiver device to the user device. In an embodiment, at block 416, the cabling assist engine 304 in the cabling assist device 200/300 may perform transceiver information provisioning operations 1700 that includes retrieving the transceiver information that was stored in the cabling assist database 306 as described above, and using the wireless communication system 308 to transmit that transceiver information via the wireless communication link 1106 and to the user device 1100.

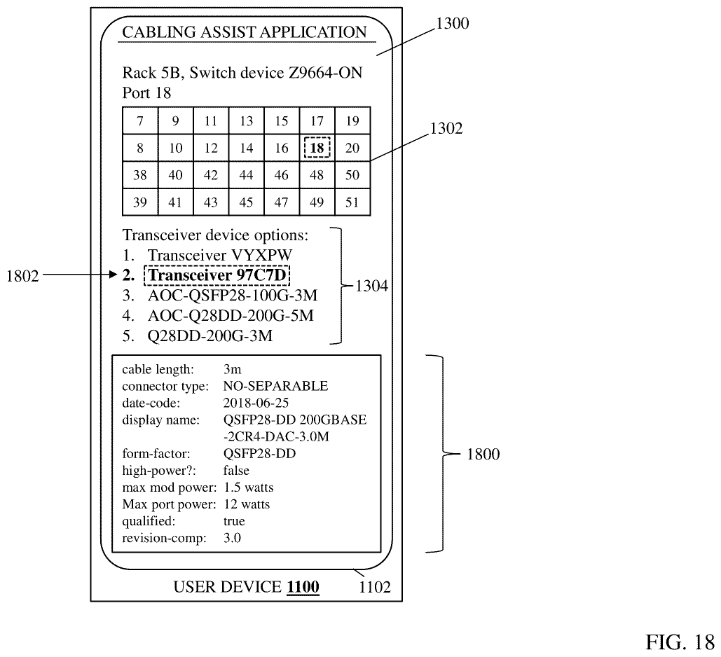

The method 400 then proceeds to block 418 where the user device displays cabling assist information based on the transceiver information and the port connection options. With reference to FIG. 18, in an embodiment of block 418, the user device 1100 may use the transceiver information received from the cabling assist device 200 at block 416 to provide a transceiver information section 1800 on the cabling assist screen 1300 via the cabling assist application running on the user device 1100. As can be seen in FIG. 18, the transceiver information section 1800 identifies a cable length (e.g., “3m”) of a cable integrated with the transceiver device 1400, a connector type (e.g., “NO SEPARABLE”) of a connector on the transceiver device 1400, a date (e.g., “2018-06-25”) associated with the transceiver device 1400, a display name (e.g., QSFP28-DD 200GBASE-2CR4-DAC-3.0M”) for the transceiver device 1400, a form-factor (e.g., “QSFP-DD”) for the transceiver device 1400, a high power identifier (e.g., “false”) for the transceiver device 1400, a maximum transceiver device power (e.g., “1.5 watts”) for the transceiver device 1400, a maximum port power (e.g., “12 watts”) for a port connected to the transceiver device 1400, a qualification indicator (e.g., “true”) for the transceiver device 1400, and revision compliance information (e.g., “3.0”) for the transceiver device 1400, and one of skill in the art in possession of the present disclosure will appreciate how the transceiver information section 1800 may identify the media lockdown state for the transceiver device 1400, the vendor of the transceiver device 1400, the vendor OUI for the transceiver device 1400, the serial number for the transceiver device 1400, the vendor part number for the transceiver device 1400, and the vendor revision for the transceiver device 1400 discussed above, and/or any other transceiver information that would be apparent to one of skill in the art in possession of the present disclosure.

Furthermore, as illustrated in FIG. 18, the user device 1100 may determine that the transceiver information identifies one of the transceiver devices identified in the port connection options section 1304 and in response, may provide a port connection option identifier 1802 for that transceiver device in the port connection options section, which in the illustrated example includes bolding the transceiver device identifier for that transceiver device and providing a dashed box surrounding the transceiver device identifier for that transceiver device, but which may include any of a variety of identification techniques that would be apparent to one of skill in the art in possession of the present disclosure.

Furthermore, while an example has been described in which the transceiver device 1400 connected to the cabling assist device 200 is identified in the port connection options 1304 displayed on the user device 1100, one of skill in the art in possession of the present disclosure will appreciate how the transceiver device 1400 connected to the cabling assist device 200 by the user may not be identified in the port connection options 1304 displayed on the user device 1100. In such a situation, the user device 1100 may display a transceiver device warning (e.g., “the transceiver device identified by the cabling assist device is not compatible with port 18”, “the transceiver device identified by the cabling assist device will not allow full functionality from port 18 or switch device ZP664-ON”, etc.), and one of skill in the art in possession of the present disclosure will appreciate how the transceiver device warning may be configured to provide any information about the transceiver device 1400, the port 506a, their compatibility, their ability to operate with each other, and/or any other transceiver device port compatibility information that would be apparent to one of skill in the art in possession of the present disclosure.

The method 400 then proceeds to decision block 420 where the method 400 proceeds depending on whether the cabling assist device is connected to another transceiver device. As will be appreciated by one of skill in the art in possession of the present disclosure, following block 418, the user may disconnect the transceiver device 1400 from the cabling assist device 200 and may connect another transceiver device to the cabling assist device. For example, in response to connecting the transceiver device 1400 to the cabling assist device 200 and receiving the transceiver device warning discussed above (e.g., due to the transceiver device 1400 not being identified in the port connection options 1304 displayed on the user device 1100), the user may find another transceiver device and connect it to the cabling assist device 200, although other reasons for connecting another transceiver device to the cabling assist device 200 will fall within the scope of the present disclosure as well.

If, at decision block 420, the cabling assist device is connected to another transceiver device, the method 400 returns to block 414. As such, the method 400 may loop such that, for each transceiver device connected to the cabling assist device 200, transceiver information is retrieved and provided to the user device 1100 so that transceiver information may be provided for display in the transceiver information section 1800, and a port connection option identifier for that transceiver device may be provided in the port connection options section 1304 if that transceiver information identifies one of the transceiver devices identified in the port connection options section 1304 (with a transceiver device warning provided if the transceiver information does not identify one of the transceiver devices identified in the port connection options section 1304). If, at decision block 406, the cabling assist device is not connected to another transceiver device, the method 400 proceeds to block 422 where the method 400 ends.

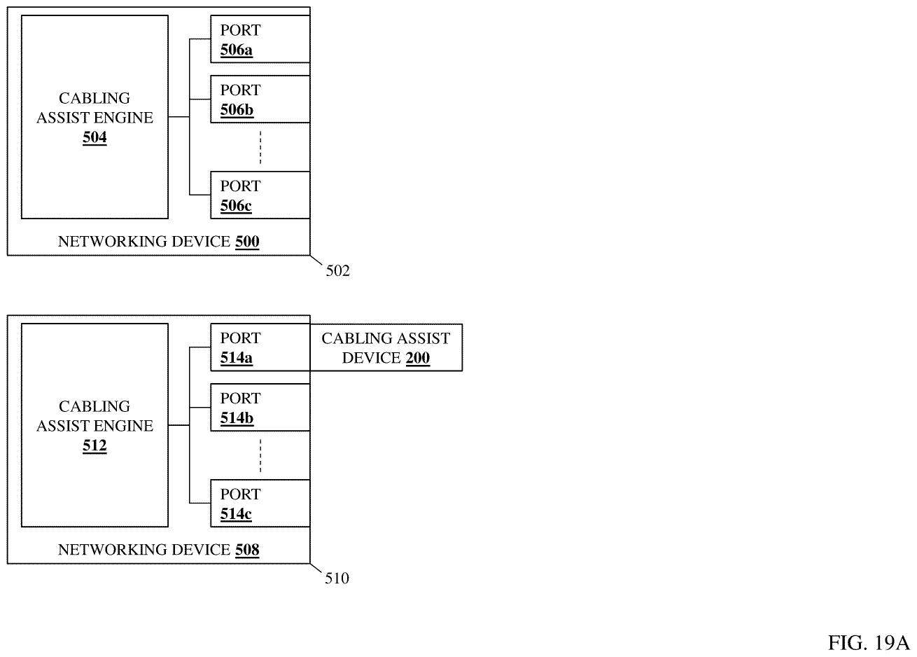

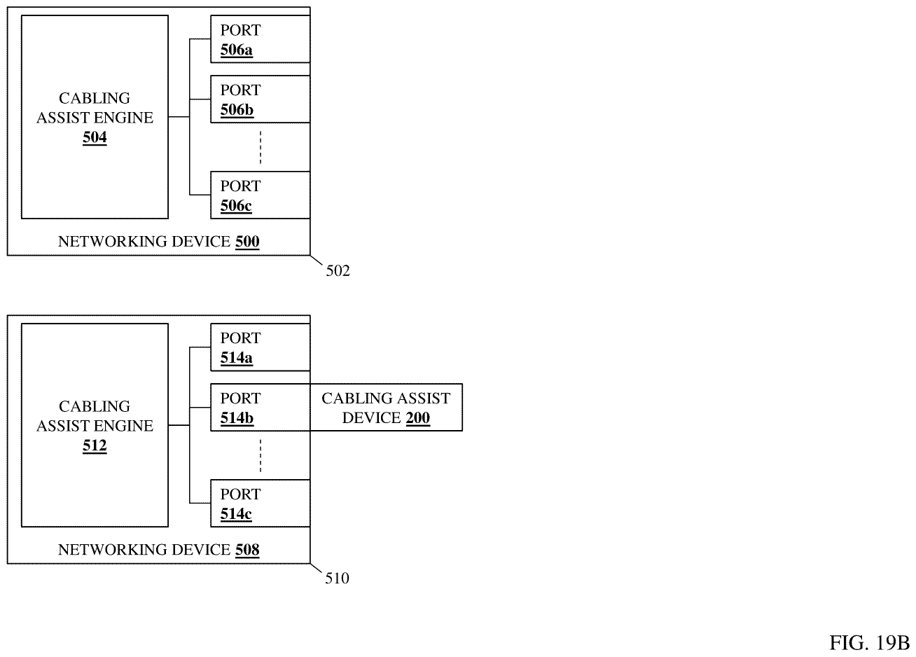

With reference to FIG. 19A, an embodiment of the method 400 is illustrated in which the cabling assist device 200 is connected to the port 514a on the networking device 508 at decision block 406 following its disconnection from the port 506a on the networking device 500, which one of skill in the art in possession of the present disclosure will appreciate will result in the cabling assist device 200 receiving port connection information for the port 514a from the cabling assist engine 512 in the networking device 508 similarly as described above for the port 506a. Similarly, with reference to FIG. 19B, an embodiment of the method 400 is illustrated in which the cabling assist device 200 is connected to the port 514b on the networking device 508 at decision block 406 following its disconnection from the port 514a on the networking device 500, which one of skill in the art in possession of the present disclosure will appreciate will result in the cabling assist device 200 receiving port connection information for the port 514b from the cabling assist engine 512 in the networking device 508 similarly as described above for the port 506a.

In the example below, the connection of the cabling assist device 200 to each of the ports 506a, 514a, and 514b results from the job sheet displayed on the user device 1100 instructing the user to cable together those ports. However, the connection of the cabling assist device 200 to each of the ports 506a, 514a, and 514b may result from the job sheet instructing the user that each of the ports 506a, 514a, and 514b must be cabled to at least one other port, with the user retrieving the port connection information for each of those ports prior to retrieving the transceiver devices for efficiency reasons (e.g., a ladder may be required to access the ports 506a, 514a, and 514b, making the separate retrieval of the port connection information and transceiver device for each port inefficient). However, while a few specific examples are provided, one of skill in the art in possession of the present disclosure will appreciate that the connection of the cabling assist device 200 to multiple ports may be performed in a variety of other cabling scenarios that will fall within the scope of the present disclosure.

Subsequently, at block 408, the cabling assist device may transmit the port connection information for the ports 506a, 514a, and 514b to the user device 1100, with the user device 1100 using that port connection information to determine port connection options for the ports 506a, 514a, and 514b by, for example, identifying transceiver devices provided on a 1:2 breakout cable in order to allow the port 506a to be cabled to the ports 514a and 514b. As will be appreciated by one of skill in the art in possession of the present disclosure, blocks 412-422 of the method 400 may proceeds similarly as described above when the user subsequently connects a transceiver device to the cabling assist device 200 (e.g., by identifying one of the port connection options that are being displayed if that transceiver device is identified as providing one of those port connection options, displaying a transceiver device warning if that transceiver device is identified as not providing one of those port connection options, etc.).

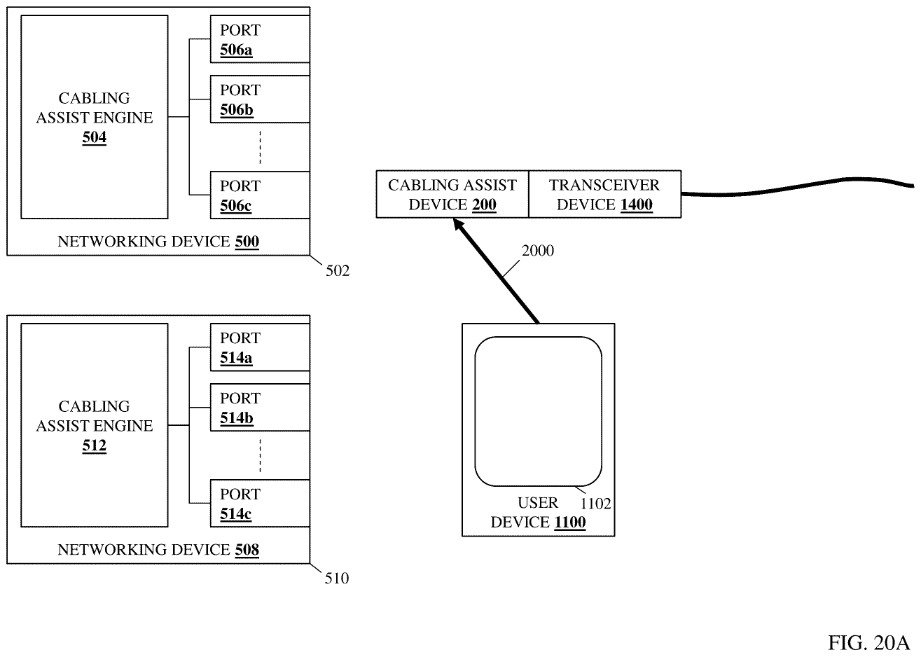

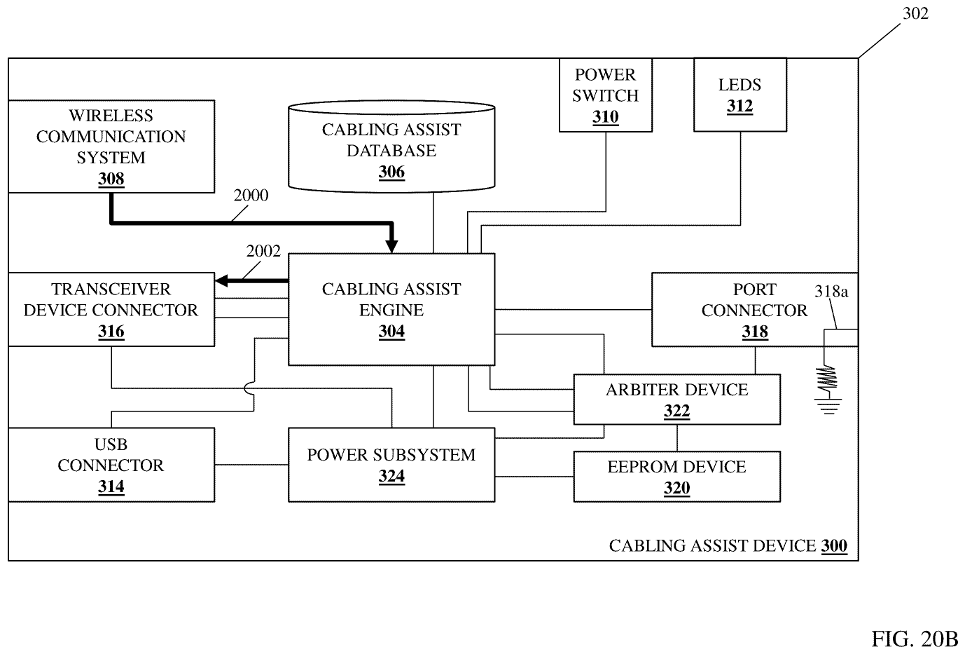

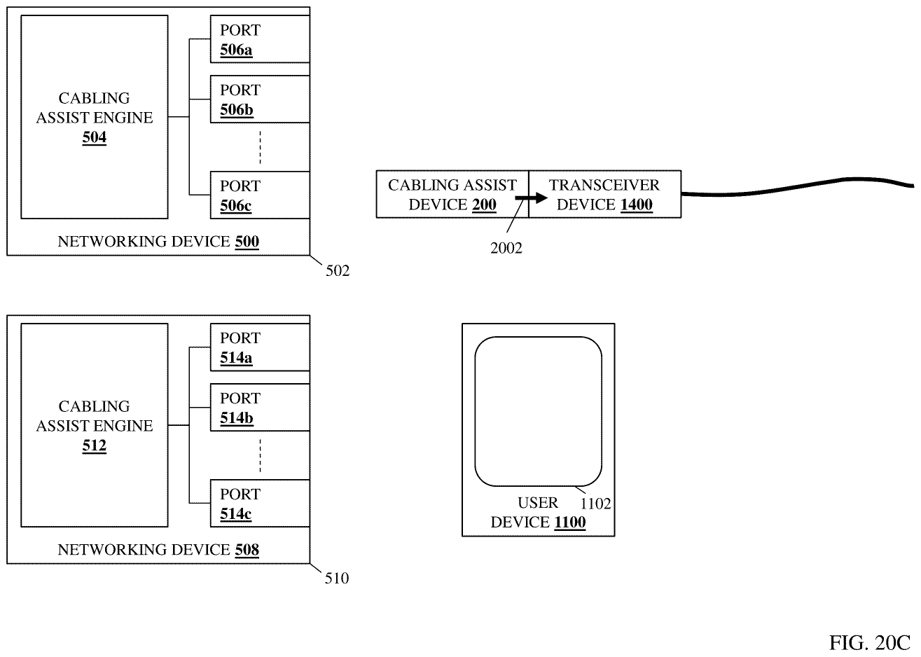

With reference to FIGS. 20A, 20B, and 20C, in some embodiments the user device 1100 may be used to write data the transceiver device 1400 if, for example, the transceiver device 1400 is identified as faulty during the method 400, in order to update qualification information for the transceiver device 1400 during its manufacture, and/or in a variety of other scenarios that would be apparent to one of skill in the art in possession of the present disclosure. As illustrated, a user may use the cabling assist application provided on the cabling assist device 200 to perform transceiver device write instruction operations 2000 that include providing an instruction to write data to the transceiver device 1400, which may be received by the cabling assist engine 304 in the cabling assist device 200/300 via the wireless communication system 308. The cabling assist engine 304 in the cabling assist device 200/300 may then perform transceiver write operations 2002 that include writing to the transceiver device 1400 (e.g., to a user-defined Type-Length-Value (TLV) field in the transceiver device 1400) via the transceiver device connector 316.

Thus, systems and methods have been described that provide a cabling assist device that is configured to connect to and collect port information for port(s) that are to-be cabled together, provide that port information to a user device so that it may display port connection options for those port(s), and then connect to and collect transceiver information from a transceiver, and provide that transceiver information to the user device so that is may display cabling assist information based on that transceiver information and the port connection options. For example, the cabling assist system of the present disclosure may include a user device, a computing device including a port, and a cabling assist device that includes a port connector and a transceiver device connector. The cabling assist device connects to the port included on the computing device via the port connector, receives port connection information for the port from the computing device, and transmits the port connection information to the user device. The user device determines port connection options for the port using the port connection information, and displays the port connection options. The cabling assist device then connects to a transceiver device via the transceiver device connector, retrieves transceiver information from the transceiver device, and transmits the transceiver information to the user device. The user device then determines that the transceiver information corresponds to a first of the port connection options, and identifies the first of the port connection options that are being displayed. As such, users may be assisted in cabling ports together to prevent many of the issues with conventional fabric connection systems discussed above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A cabling assist system, comprising:
a user device;
a first computing device including a first port; and
a cabling assist device that includes a port connector and a transceiver device connector, wherein the cabling assist device is configured to:
connect, via the port connector, to the first port included on the first computing device;
receive, from the first computing device, first port connection information for the first port;
transmit, to the user device, the first port connection information, wherein the user device is configured to:
determine a plurality of first port connection options for the first port using the first port connection information; and
display the plurality of first port connection options;
connect, via the transceiver device connector, to a first transceiver device;
retrieve, from the first transceiver device, first transceiver information;
transmit, to the user device, the first transceiver information, wherein the user device is configured to:
determine that the first transceiver information corresponds to a first of the plurality of first port connection options; and
identify the first of the plurality of first port connection options that are being displayed.

2. The system of claim 1, wherein the cabling assist device is configured to:
establish a wireless connection with the user device and use the wireless connection to transmit the first port connection information and the first transceiver information to the user device.

3. The system of claim 1, wherein first port connection information includes a prioritized list of transceiver device identifiers, and wherein the first port connection options are provided by the prioritized list of transceiver device identifiers.

4. The system of claim 1, wherein the port connector is a Quad Small Form-factor Pluggable (QSFP) port connector, and wherein the transceiver device connector is configured to receive a QSFP transceiver device.

5. The system of claim 1, further comprising:
a light emitting device included on the cabling assist device, wherein the cabling assist device is configured to:
activate, in response to receiving the first port connection information for the first port from the first computing device, the light emitting device.

6. The system of claim 1, further comprising:
a second computing device including a second port, wherein the cabling assist device is configured to:
connect, via the port connector, to the second port included on the second computing device;
retrieve, from the second computing device, second port connection information for the second port; and
transmit, to the user device, the second port connection information, wherein the user device is configured to:
determine the plurality of first port connection options for the first port using the first port connection information and the second port connection information.

7. The system of claim 1, wherein the user device is configured to:
determine a plurality of second port connection options for the second port using the second port connection information; and
display the plurality of second port connection options, and wherein the cabling assist device is configured to:
connect, via the transceiver device connector, to a second transceiver device;
retrieve, from the second transceiver device, second transceiver information;
transmit, to the user device, the second transceiver information, wherein the user device is configured to:
determine that the second transceiver information corresponds to a first of the plurality of second port connection options; and
identify the first of the plurality of second port connection options that are being displayed.

8. A cabling assist device, comprising:
a chassis;
a port connector that is included on the chassis;
a transceiver device connector that is included on the chassis;
a processing system that is coupled to the port connector and the transceiver device connector; and
a memory system that is coupled to the processing system and that includes instructions that, when executed by the processing system, cause the processing system to provide a cabling assist engine that is configured to:
connect, via the port connector, to a first port included on a first computing device;
receive, from the first computing device, first port connection information for the first port;
transmit, to a user device, the first port connection information;
connect, via the transceiver device connector, to a first transceiver device;
retrieve, from the first transceiver device, first transceiver information; and
transmit, to the user device, the first transceiver information.

9. The device of claim 8, wherein the cabling assist engine is configured to:
establish a wireless connection with the user device and use the wireless connection to transmit the first port connection information and the first transceiver information to the user device.

10. The device of claim 8, wherein first port connection information includes a prioritized list of transceiver device identifiers, and wherein the first port connection options are provided by the prioritized list of transceiver device identifiers.

11. The device of claim 8, wherein the port connector is a Quad Small Form-factor Pluggable (QSFP) port connector, and wherein the transceiver device connector is configured to receive a QSFP transceiver device.

12. The device of claim 8, further comprising:
a light emitting device included on the chassis, wherein the cabling assist engine is configured to:
activate, in response to receiving the first port connection information for the first port from the first computing device, the light emitting device.

13. The device of claim 8, wherein the cabling assist engine is configured to:
connect, via the transceiver device connector, to a second transceiver device;
retrieve, from the second transceiver device, second transceiver information;
transmit, to the user device, the second transceiver information.

14. A method for assisting with the cabling of computing devices, comprising:
connecting, by a cabling assist device via a port connector included on the cabling assist device, to a first port included on a first computing device;
receiving, by the cabling assist device from the first computing device, first port connection information for the first port;
transmitting, by the cabling assist device to a user device, the first port connection information;
connecting, by the cabling assist device via a transceiver device connector included on the cabling assist device, to a first transceiver device;
retrieving, by the cabling assist device from the first transceiver device, first transceiver information; and
transmitting, by the cabling assist device to the user device, the first transceiver information.

15. The method of claim 14, further comprising:
establishing, by the cabling assist device, a wireless connection with the user device and using the wireless connection to transmit the first port connection information and the first transceiver information to the user device.

16. The method of claim 14, wherein first port connection information includes a prioritized list of transceiver device identifiers, and wherein the first port connection options are provided by the prioritized list of transceiver device identifiers.

17. The method of claim 14, wherein the port connector is a Quad Small Form-factor Pluggable (QSFP) port connector, and wherein the transceiver device connector is configured to receive a QSFP transceiver device.

18. The method of claim 14, further comprising:
activating, by the cabling assist device in response to receiving the first port connection information for the first port from the first computing device, a light emitting device included on the chassis.

19. The method of claim 14, further comprising:
connecting, by the cabling assist device via the transceiver device connector, to a second transceiver device;
retrieving, by the cabling assist device from the second transceiver device, second transceiver information;
transmitting, by the cabling assist device to the user device, the second transceiver information.

20. The method of claim 14, further comprising:
determining, by the user device, a plurality of first port connection options for the first port using the first port connection information;
displaying, by the user device, the plurality of first port connection options;
determining, by the user device, that the first transceiver information corresponds to a first of the plurality of first port connection options; and
identifying, by the user device, the first of the plurality of first port connection options that are being displayed.
